(19) United States
(12) Patent Application Publication
(10) Pub. No.: US 2003/0191772 A1
(43) Pub. Date: Oct. 9, 2003

(54) Electronic meeting management system and an associated method of scheduling meetings

(76) Inventors: Scott Schaumann, Manchester, MO (US); Brad Atkinson, O' Fallon, MO (US); Dave Finnegan, St. Charles, MO (US)

Correspondence Address: BLACKWELL SANDERS PEPER MARTIN LLP, 720 OLIVE STREET, SUITE 2400, ST. LOUIS, MO, 63101, US

(21) Appl. No.: 10/407,601

(22) Filed: Apr. 4, 2003

Related U.S. Application Data
(60) Provisional application No. 60/369,913, filed on Apr. 4, 2002.

(51) Int. Cl. G06F 17/00

(52) U.S. Cl. 707/102

(57) ABSTRACT

An electronic meeting management system and an associated method of managing a meeting, utilizing at least one database, which includes selecting a facility, selecting a date for the meeting, inputting a number of people to attend the meeting, selecting a portion of the day in which to schedule the meeting, retrieving from the database at least one available time and date for the meeting at the selected facility, selecting a particular time and date for the meeting at the selected facility, from the at least one retrieved time and date for the meeting, and receiving an output of a confirmation of a reserved meeting. Alternative dates and times can be outputted by the system. In addition, an electronic payment mechanism can be utilized to make a deposit to reserve the meeting.

### CROSS-REFERENCE TO RELATED APPLICATION

This patent application claims priority to U.S. Provisional Patent Application Serial No. 60/369,913 filed Apr. 4, 2002.

### BACKGROUND OF THE INVENTION

This invention relates to the electronic scheduling of meetings, and more particularly, to an electronic meeting management system and an associated method of scheduling meetings. The scheduling of meetings is a very time consuming administrative function. Meetings can include virtually any type of activity where people get together and have face-to-face interaction. This can encompass a wide variety of activities and events including, but not limited to, birthday parties, boy scout parties, girl scout parties, and so forth. The administrative aspect of scheduling meetings is especially difficult for meetings that occur at particular locations having a fixed amount of resources. For example, if someone desires to schedule a party at a retail establishment, this person must communicate with one of the few people trained and authorized to enter this information into the computer. If several people want to reserve a meeting, e.g., party, at the same time and place, there can be issues as to which party reserved first and when the information was entered. The customer or meeting attendee can be told that the time is free while another employee reserves the exact same date, time and location before the first employee can complete the transaction. This can be very detrimental to the relationship with that customer. One approach utilized by organizations, in an attempt to address this issue, is to obtain suggested dates and times from customers via phone or e-mail. This information is then directed to one particular designated employee. The problem with this system is that this employee is constantly involved with this function and when things are busy there can be a considerable lag between receiving an indication of interest and responding to any one particular customer. In addition, there may need to be considerable interaction between the customer and the employee if the desired location, date and time is already reserved. Moreover, although this administrative task is essential to the organization, it is very time consuming and repetitious. This makes it is very difficult for the employer to keep and retain quality employees. Furthermore, the customer is frustrated since he or she must spend a considerable time on the phone to determine all available options if the optimal facility, date and time has been already reserved.

The present invention is directed to overcoming one or more of the problems set forth above.

### SUMMARY OF INVENTION

In one aspect of this invention, a computer system for managing a meeting utilizing at least one database associated with at least one processor is disclosed. This system includes an input mechanism that receives a selected facility, a selected date for the meeting, a number of people to attend the meeting, a portion of the day in which to schedule the meeting, and an output mechanism that retrieves from the database at least one available time and date for the meeting at the selected facility, wherein the input mechanism further includes receiving an input for one particular date, time and facility of the at least one retrieved time and date for the meeting at the selected facility and the output mechanism provides a confirmation of the selected date, time and facility for the meeting. Throughout this application, each database preferably, but not necessarily, includes a separate processor used in conjunction therewith, in addition to at least one processor.

In another aspect of this invention, a method for managing a meeting utilizing at least one database is disclosed. This method includes selecting a facility, selecting a date for the meeting, inputting a number of people to attend the meeting, selecting a portion of the day in which to schedule the meeting, retrieving from the database at least one available time and date for the meeting at the selected facility, selecting a particular time and date for the meeting at the selected facility, from the at least one retrieved time and date for the meeting, and receiving an output of a confirmation of a reserved meeting.

Still another aspect of this invention, a computer software interface that is capable of being connected to a database for managing a meeting is disclosed. This software interface includes an input that provides a facility selection, an input that provides a meeting date selection, an input that provides an attendance number for a meeting, an input that selects a portion of the day in which to schedule the meeting, an output that retrieves at least one available time and date for the meeting at the selected facility, an input that provides a selection of a particular time and date for the meeting at the selected facility, from the at least one retrieved time and date for the meeting, and an output that provides a confirmation of a reserved meeting.

These are merely three of the illustrative aspects of the present invention and should not be deemed an all-inclusive listing of the innumerable aspects associated with the present invention. These and other aspects will become apparent to those skilled in the art, in view of the following disclosure and accompanying drawings.

### BRIEF DESCRIPTION OF DRAWINGS

For a better understanding of the present invention, reference may be made to the accompanying drawings in which:

FIG. 1 is a schematic diagram of a series of software programs and associated database of the present invention for a meeting management system and associated method of scheduling meetings;

FIG. 2 is a flowchart of a system management interface for an information and tracking system associated with the present invention;

FIG. 3 is a flowchart of a reservation (time blocking, e.g., “hibernation”) function for scheduled meetings at a selected facility associated with the present invention;

FIG. 4 is a flowchart of a meeting and facility status information system for a facility interface program associated with the present invention;

FIG. 5 is a flowchart of a meeting scheduling system that is electronically accessed via either a processor located at a kiosk at a facility or a processor electrically connected to a global communications network, e.g., Internet, associated with the present invention;

FIG. 6 is an exemplary screen display of a graphical user interface for accessing the system management interface for an information and tracking system associated with the present invention, as detailed in the flowchart of FIG. 2, by system users, e.g., employees;

FIG. 7 is an exemplary screen display of a graphical user interface for tracking a product or service order utilizing the system management interface for an information and tracking system associated with the present invention as detailed in the flowchart of FIG. 2;

FIG. 8 is an exemplary screen display of a graphical user interface for placing a new product or service order utilizing the system management interface for an information and tracking system associated with the present invention as detailed in the flowchart of FIG. 2;

FIG. 9 is an exemplary screen display of a graphical user interface for accessing an existing product or service order utilizing the system management interface through a log-in for an information and tracking system associated with the present invention as detailed in the flowchart of FIG. 2;

FIG. 10 is an exemplary screen display of a graphical user interface for viewing a listing of meeting attendees or customers that are scheduled to be present for at least one meeting, e.g., party, which is collected based on search criteria utilizing the system management interface for an information and tracking system associated with the present invention as detailed in the flowchart of FIG. 2;

FIG. 11 is an exemplary screen display of a graphical user interface for editing and viewing personal and household information regarding meeting attendees or customers, which is accessed by clicking an either a view or edit hyperlink as shown in FIG. 10;

FIG. 12 is an exemplary screen display of a graphical user interface for viewing. a listing of meeting attendees or customers and a history for each meeting utilizing the system management interface for an information and tracking system associated with the present invention as detailed in the flowchart of FIG. 2;

FIG. 13 is an exemplary screen display of a graphical user interface for editing and viewing information regarding a particular meeting utilizing the system management interface for an information and tracking system associated with the present invention as detailed in the flowchart of FIG. 2;

FIG. 14 is an exemplary screen display of a graphical user interface for inserting and editing information regarding meetings occurring at a facility, e.g., store, utilizing the system management interface for an information and tracking system associated with the present invention as detailed in the flowchart of FIG. 2;

FIG. 15 is an exemplary screen display of an automatically generated letter that either confirms or cancels, e.g., cancels, a proposed meeting utilizing the system management interface for an information and tracking system associated with the present invention as detailed in the flowchart of FIG. 2;

FIG. 16 is an exemplary screen display of a graphical user interface for accessing a reservation (time blocking, e.g., hibernation) function for scheduled meetings associated with the present invention by system users, e.g., employees, as detailed in the flowchart of FIG. 3;

FIG. 17 is an exemplary screen display of a graphical user interface for querying the reserved (blocked, e.g., hibernation) times based on the name of the particular party accessing the reservation (time blocking, e.g., hibernation) function for scheduled meetings associated with the present invention by system users, e.g., employees, as detailed in the flowchart of FIG. 3;

FIG. 18 is an exemplary screen display of a graphical user interface for querying the reserved (blocked, e.g., hibernation) times based on the previously reserved times (block-outs, e.g. hibernations) for scheduled meetings associated with the present invention by system users, e.g., employees, as detailed in the flowchart of FIG. 3;

FIG. 19 is an exemplary screen display of a graphical user interface for creating a reserved (blocked, e.g., hibernation) time for a scheduled meeting, e.g., party, associated with the present invention by system users, e.g., employees, as detailed in the flowchart of FIG. 3;

FIG. 20 is an exemplary screen display of a graphical user interface for deleting a reserved (blocked, e.g., hibernation) time for a scheduled meeting, e.g., party, associated with the present invention by system users, e.g., employees, as detailed in the flowchart of FIG. 3;

FIG. 21 is an exemplary screen display of a graphical user interface for accessing a meeting and facility status information system by a user, e.g., employee, at a facility as detailed in the flowchart of FIG. 4. This exemplary screen display of a graphical user interface includes an introduction/home page for the network accessible by employees, e.g., “Bearnet”;

FIG. 22 is an exemplary screen display of a graphical user interface for accessing meetings, e.g., parties, based on a predetermined period of time, e.g., the current week, of meetings occurring at a particular facility for a user at that facility, as detailed in the flowchart of FIG. 4;

FIG. 23 is an exemplary screen display of a graphical user interface for accessing detailed information regarding a particular meeting, e.g., party, occurring at a particular facility for a user at that facility, as detailed in the flowchart of FIG. 4;

FIGS. 24A, 24B and 24C are an exemplary screen display of a graphical user interface for providing background information regarding scheduling a meeting, e.g., party, occurring at a particular facility by a meeting attendee or customer;

FIGS. 24D and 24E are an exemplary screen display of a graphical user interface for scheduling a meeting, e.g., party, occurring at a particular facility by a meeting attendee or customer located at that facility's computer as detailed in the flowchart of FIG. 5 including a preferred facility, a preferred date, a preferred portion of the day, a number of meeting attendees or customers and an average age of the meeting attendees or customers;

FIGS. 25A and 25B are an exemplary screen display of a graphical user interface for selecting a preferred date and time for a meeting, e.g., party, occurring at a particular facility by a meeting attendee or customer located at that facility's computer terminal, e.g., kiosk, as detailed in the flowchart of FIG. 5;

FIGS. 26A and 26B are an exemplary screen display of a graphical user interface for designating the occasion for an meeting, e.g., party, occurring at a particular facility for a meeting attendee or customer located at that facility's computer terminal, e.g., kiosk, as detailed in the flowchart of FIG. 5;

FIGS. 27A, 27B, 27C, 27D and 27E are an exemplary screen display of a graphical user interface for providing additional informational input from a meeting attendee or customer regarding a meeting, e.g., party, occurring at a particular facility for a meeting attendee or customer located at that facility's computer as detailed in the flowchart of FIG. 5;

FIGS. 28A, 28B, 28C and 28D are an exemplary screen display of a graphical user interface for receiving confirmation of a reserved meeting, e.g., party, occurring at a particular facility by a meeting attendee or customer located at that facility's computer as detailed in the flowchart of FIG. 5;

FIG. 29 is an exemplary screen display of a graphical user interface for providing additional marketing information and contacts for a meeting attendee or customer utilizing a global computer network, e.g., Internet, as detailed in the flowchart of FIG. 5 for scheduling a meeting, e.g., party;

FIGS. 29A and 29B are an exemplary screen display of a graphical user interface for scheduling a meeting, e.g., party, occurring at a particular facility by a meeting attendee or customer utilizing a global computer network, e.g., Internet, as detailed in the flowchart of FIG. 5 including a preferred facility, a preferred date, a preferred portion of the day, a number of meeting attendees or customers and an average age of meeting attendees or customers;

FIG. 30 is an exemplary screen display of a graphical user interface for selecting a preferred date and time or an alternative date and time for a meeting, e.g., party, occurring at a particular facility by a meeting attendee or customer utilizing a global computer network, e.g., Internet, as detailed in the flowchart of FIG. 5;

FIG. 31 is an exemplary screen display of a graphical user interface for designating the occasion for a meeting, e.g., party, occurring at a particular facility by a meeting attendee or customer utilizing a global computer network, e.g., Internet, as detailed in the flowchart of FIG. 5;

FIGS. 32A, 32B and 32C are an exemplary screen display of a graphical user interface for providing informational input from a meeting attendee or customer regarding an alternative example of a meeting, e.g., party, occurring at a particular facility for a meeting attendee or customer utilizing a global computer network, e.g., Internet, as detailed in the flowchart of FIG. 5;

FIGS. 33A and 33B are an exemplary screen display of a graphical user interface that provides an output of frequently-asked questions regarding the meeting, e.g., party, as well as how to schedule the meeting, e.g., party, utilizing a global computer network, e.g., Internet, as detailed in the flowchart of FIG. 5;

FIG. 34 is an exemplary screen display of a graphical user interface that provides an address, contact information, telephone numbers, potential food providers, with a map with directions for a selected facility that is having the meeting, e.g., party, for a meeting attendee or customer utilizing a global computer network, e.g., Internet, as detailed in the flowchart of FIG. 5;

FIG. 35 is an exemplary screen display of a graphical user interface that provides an input for a facility, e.g., store, to ascertain the food service providers associated with a particular facility, e.g., store, for a meeting attendee or customer utilizing a global computer network, e.g., Internet, as detailed in the flowchart of FIG. 5.

FIG. 36 is an exemplary screen display of a graphical user interface that provides contact information regarding the food service providers associated with a particular facility, e.g., store, selected by meeting attendee or customer through the graphical user interface shown in FIG. 35 utilizing a global computer network, e.g., Internet;

FIG. 37 is an exemplary display of a written form for providing information that can be utilized in a storybook or certificate by a meeting attendee or customer utilizing a global computer network, e.g., Internet, as detailed in the flowchart of FIG. 5;

FIG. 38 is an exemplary screen display of a graphical user interface for allowing the user to create invitations or thank you cards related to a meeting, e.g., party, occurring at a particular facility by a meeting attendee or customer utilizing a global computer network, e.g., Internet, as detailed in the flowchart of FIG. 5;

FIG. 39 is an exemplary screen display of a graphical user interface for allowing the user to provide information in order to create invitations related to a meeting, e.g., party, occurring at a particular facility by a meeting attendee or customer utilizing a global computer network, e.g., Internet, as detailed in the flowchart of FIG. 5;

FIG. 40 is an exemplary screen display of a graphical user interface for allowing the user to customize invitations, such as coloration and layout, related to a meeting, e.g., party, occurring at a particular facility by a meeting attendee or customer utilizing a global computer network, e.g., Internet, as detailed in the flowchart of FIG. 5;

FIG. 41 is an exemplary screen display of a graphical user interface for allowing the user to provide information in order to create thank you cards related to a meeting, e.g., party, occurring at a particular facility by a meeting attendee or customer utilizing a global computer network, e.g., Internet, as detailed in the flowchart of FIG. 5;

FIG. 42 is an exemplary screen display of a graphical user interface for allowing the user to customize thank you cards, such as coloration and layout, related to a meeting, e.g., party, occurring at a particular facility by a meeting attendee or customer utilizing a global computer network, e.g., Internet, as detailed in the flowchart of FIG. 5;

FIGS. 43A and 43B is an exemplary screen display of a graphical user interface for allowing the user to provide information in order to create e-mail invitations related to a meeting, e.g., party, occurring at a particular facility by a meeting attendee or customer utilizing a global computer network, e.g., Internet, as detailed in the flowchart of FIG. 5; and

FIG. 44 is an exemplary screen display of a graphical user interface for sending, confirming and potentially changing an e-mail invitation related to a meeting, e.g., party, occurring at a particular facility by a meeting attendee or customer utilizing a global computer network, e.g., Internet, as detailed in the flowchart of FIG. 5.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. For example, the invention is not limited in scope to the particular type of industry application depicted in the figures, a particular type of software language, or to particular conventions regarding software designations. In other instances, well-known methods, procedures, and components have not been described in detail so as not to obscure the present invention. A processor referred to herein can be a single processor or a whole series of processors. The preferred method of communication for this invention is through a global computer network, e.g., Internet, however, there are numerous mechanisms for electronic communication that might suffice for this present invention.

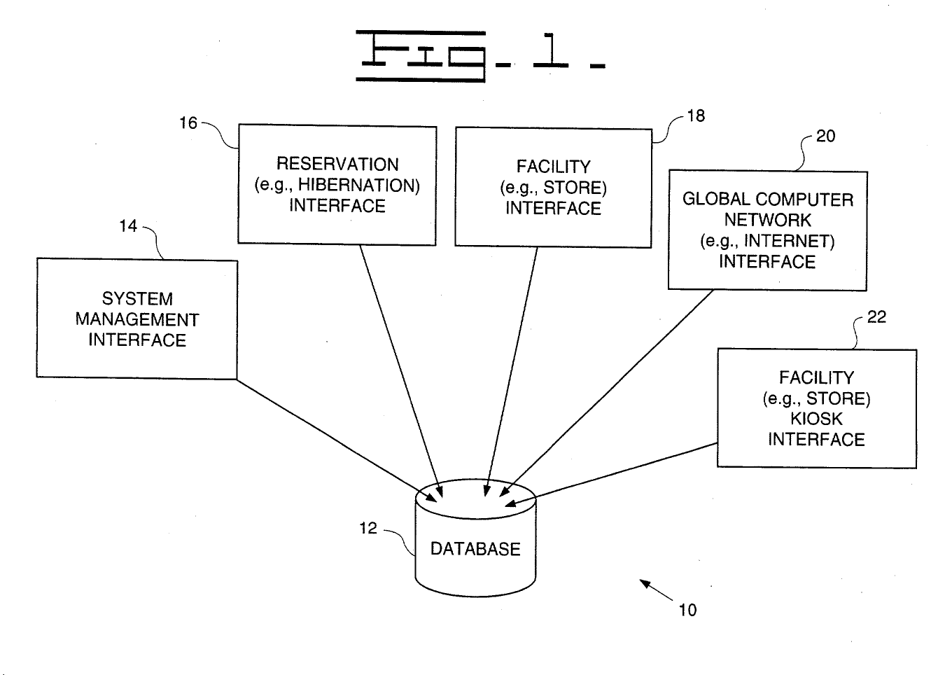

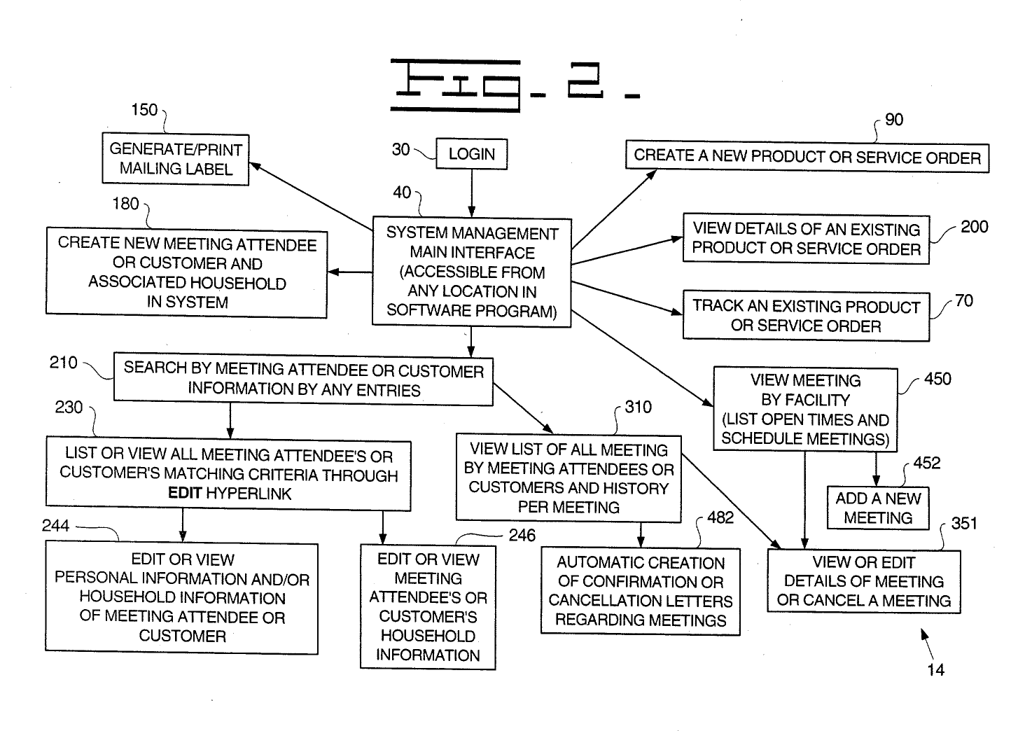

Referring now to the drawings, and initially to FIG. 1, which is a contextual schematic of the electronic meeting management system of the present invention that is generally indicated by numeral 10. There is a database 12 that preferably provides access to five (5) different software programs. These software programs include a system management interface program 14, a reservation (time blocking, e.g., hibernation) interface program 16 for a facility, a facility interface program 18, a meeting scheduling interface program 20 accessible from a remote location utilizing a global computer network, e.g., Internet, and a meeting scheduling interface program 22 accessible from a facility, e.g., store, from a processor located at the facility's kiosk or similar type of access and display. A wide variety of electronic communication mechanisms can be utilized to link these interface programs 14, 16, 18, 20 and 22 to a database 12, with the preferred mechanism being a global computer network, e.g., Internet. The database 12 can be associated with one main processor or series of multiple processors. The separation of the functional features associated with the present invention into five (5) interface programs 14, 16, 18, 20 and 22 is merely for illustration only and select features from these programs 14, 16, 18, 20 and 22 can be combined, eliminated, augmented or further segregated depending on the specific application that is involved.

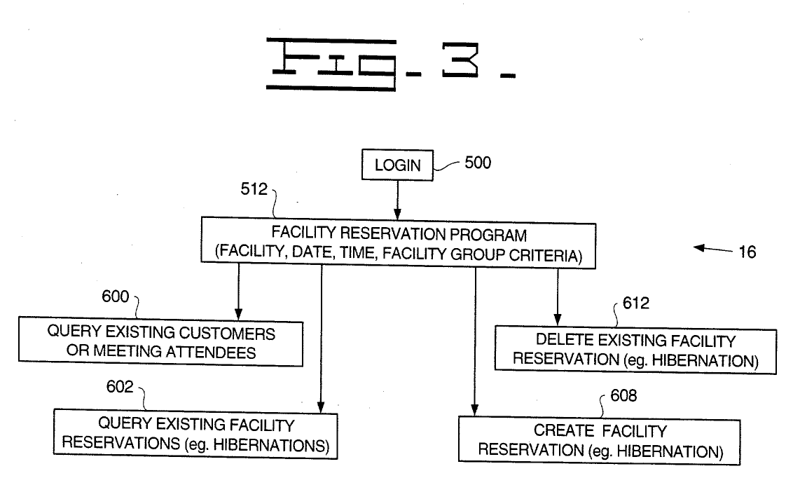

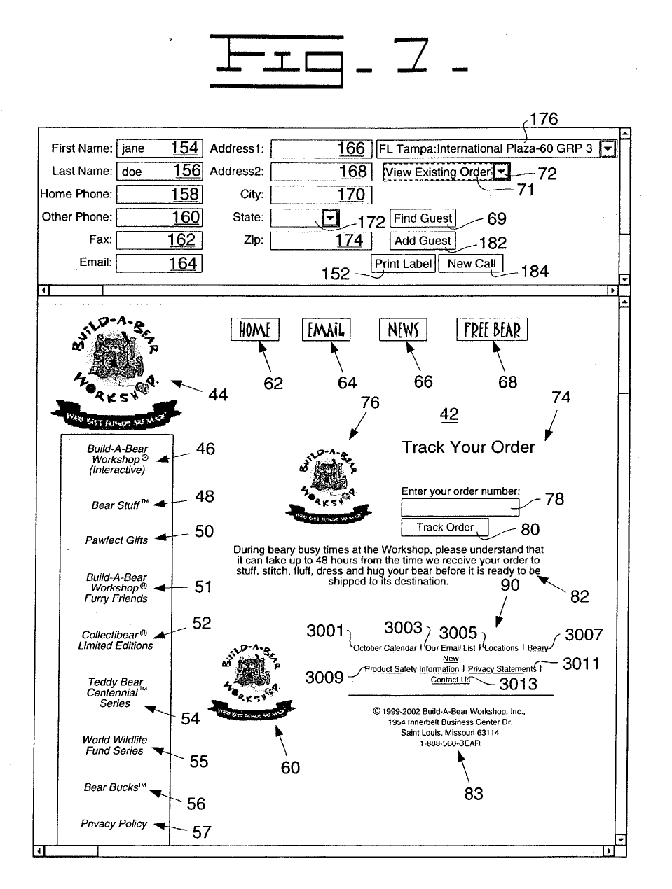

In the description of flowcharts, the functional explanation marked with numerals in angle brackets, <nnn>, will refer to the flowchart blocks bearing that number. Referring now to FIG. 2, the first step in accessing the system management interface 14, as is also shown in FIG. 1, is for the user, e.g., employee, at a facility, e.g., store, to login into the system of the present invention <30>. As shown on the exemplary graphical interface screen display for the login function shown in FIG. 6 and generally indicated by numeral 31, this can include an organizational logo 32, an input for the user's, e.g., employee's, name 34, the user's, e.g., employee's, password 36, and a pushbutton 38 for submitting the user's, e.g., employee's, name and the user's, e.g., employee's, password to the system of the present invention. There is a disclaimer for this system that indicates that the system is for “Authorized Use Only”, which is generally indicated by numeral 33.

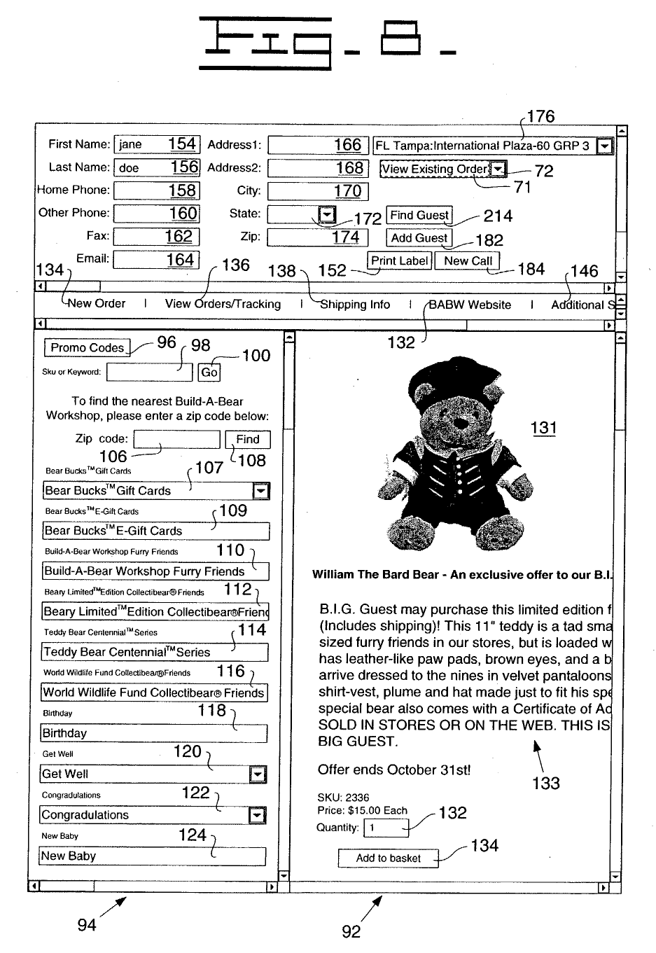

The second step in the system management interface 14 is a system management main interface screen <40> as shown in FIG. 2. As shown on the exemplary graphical interface screen display shown in FIG. 7 and generally indicated by numeral 42, this can include an organizational logo 44, a first hyperlink for building a custom product 46, a second hyperlink for selecting complementary items for a selected product, e.g., clothing and accessories, 48, a third hyperlink for custom designing a product to be shipped as a gift 50, a fourth hyperlink to a listing of select products 51, a fifth hyperlink to a listing of limited edition products 52, a sixth hyperlink to a specific series of products 54, a seventh hyperlink for products that include a contribution to a charity with a purchase of each product, e.g., World Wildlife Fund, 55, an eighth hyperlink for gift certificates 56, a ninth hyperlink to a privacy policy associated with the system of the present invention 57 and a second logo and informational display 60. There is a tenth hyperlink that directs the user to the system's current home page 62, an eleventh hyperlink that provides an e-mail function 64 that directs correspondence from the user to the system of the present invention, a twelfth hyperlink that provides news to the user about the organization for the system 66 of the present invention and a thirteenth hyperlink that provides information to the user regarding a complimentary product 68.

The first function in the system management interface 14 is an order tracking function <70> as shown in FIG. 2. This is illustrated on the exemplary graphical interface screen display 42, shown in FIG. 7, with the selection of the “order tracking” function is generally indicated by numeral 71 and accomplished through a drop-down selector input 72. There is a heading 74 and a logo 76 present on the interface screen display 42.

The order number is provided by the user through a data input 78. There is a graphical interface pushbutton input 80 for entering the order number in order to track the order associated with the order number provided in data input 78. The graphical interface screen display 42 also includes an output for shipping/order fulfillment information 82.

There is a second collection of hyperlinks that is generally indicated by numeral 90. This includes a fourteenth hyperlink to a calendar feature 3001, a fifteenth hyperlink to a listing of e-mail addresses 3003, a sixteenth hyperlink to facility, e.g., store, locations 3005, a seventeenth hyperlink that provides news to the user about the organization for the system of the present invention 3007, an eighteenth hyperlink to direct the user to product safety information 3009, a nineteenth hyperlink to direct the user to a privacy statement or policy 3011, and a twentieth hyperlink that allows the user to contact the system of the present invention 3013. This is in addition to general information, e.g., address, copyright, phone number, 83 regarding the organization associated with the system of the present invention.

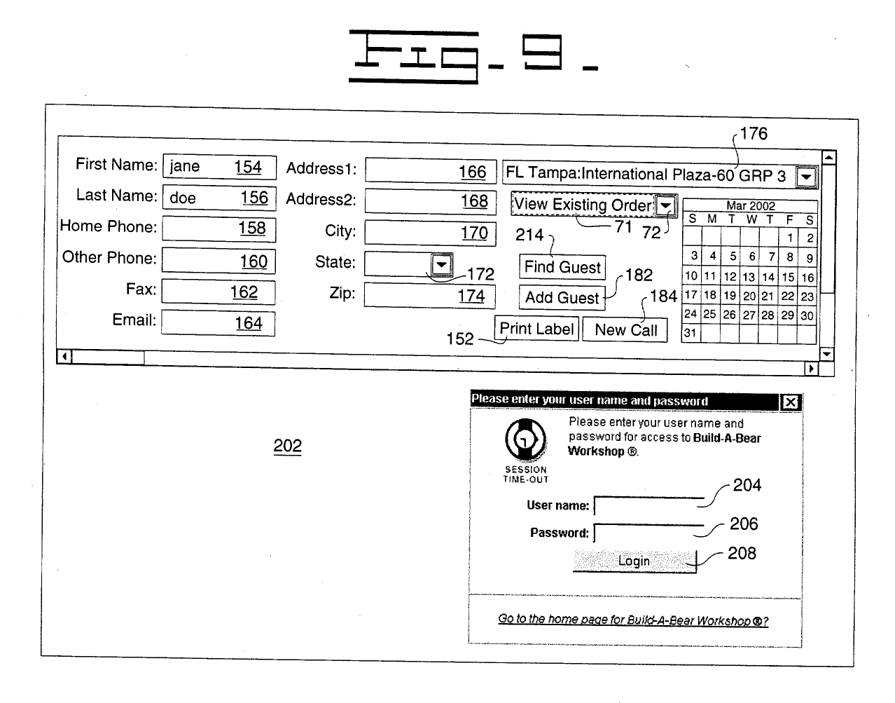

The second function in the system management interface 14 is a product or service order creation function <90> as shown in FIG. 2. As shown on the exemplary graphical interface screen display 92 shown in FIG. 8, this includes a series of drop-down selector inputs and data inputs that are generally indicated by numeral 94. This can include as illustrative, but nonlimiting, examples: a pushbutton input for promotional codes 96; an input 98 for a stock keeping unit “sku” or keyword with associated pushbutton 100; an input for a zip code to determine the closest facility, e.g., store, 106; and an associated pushbutton 108, a drop-down selector input for gift certificates or cards 107; a drop-down selector input for electronic gift certificates or cards 107 that can be sent via e-mail and include a account number and a personal identification number (PIN) number; a drop-down selector input for specific products 110; a drop-down selector input for limited edition products 112; a drop-down selector input for a special series of products 114; a drop-down selector input for series of products that are directed to products that include a donation to charity and/or promote important issues 116. In addition, there can be a drop-down selector input indicating the occasion for the purchase includes a particular type of birthday celebration 118, a drop-down selector input indicating the occasion for the purchase is that the person receiving the product is desired to get well 120, a drop-down selector inputs indicating the occasion for the purchase is that the person receiving the product is to be congratulated 122, and a drop-down selector input indicating the occasion for the purchase is that the person receiving the product has a new baby 124. These are merely illustrative examples of the innumerable reasons for purchasing a product or service.

An illustrative picture of a product includes that indicated by numeral 131 with an input to provide the desired quantity 132 with a pushbutton 134 to add the product to a basket of selected items for purchase. This invention could just as easily be applied to the rendering of services by the organization of the present invention rather than the purchasing of goods.

As also shown on the exemplary graphical interface screen display 92 shown in FIG. 8, there is a series of pushbuttons that can include a first pushbutton 134 for ordering a new product or service, a second pushbutton 136 for viewing or tracking an order for a product or service, a third pushbutton 138 that directs the user to shipping information, a fourth pushbutton 132 that directs the user to a webpage for the organization associated with the system of the present invention and a fifth pushbutton 146 that directs the user to purchase additional components for the products, e.g., sound generating devices 146. There may also be an additional pushbutton that directs the user back to the main or home page of the system associated with the present invention (not shown) as indicated by process step <40> on FIG. 2.

The third function in the system management interface 14 is a mail label generation and printing function <150> as shown in FIG. 2. As shown on the exemplary graphical interface screen display 92, illustrated in FIG. 8, this is accomplished with a “print label” pushbutton 152. This includes information from the following data input/outputs that includes a customer's or meeting attendee's first name input 154, a customer's or meeting attendee's last name input 156, a customer's or meeting attendee's home phone number input 158, a customer's or meeting attendee's other phone number input 160, a customer's or meeting attendee's facsimile number input 162, a customer's or meeting attendee's e-mail address input 164, a customer's or meeting attendee's first address line input 166, a customer's or meeting attendee's second address line input 168, a customer's or meeting attendee's city input 170, a customer's or meeting attendee's state drop-down selector input 172, a customer's or meeting attendee's zip code input 174, and a customer's or meeting attendee's facility location name from a drop-down selector input 176, which may include other identifying information including the state and the city for the facility.

The fourth function in the system management interface 14 is to create a new meeting attendee or customer in the system of the present invention with associated household information through input function <180> as shown in FIG. 2. As shown on the exemplary graphical interface screen display 92, illustrated in FIG. 8, this is accomplished with a “add guest” pushbutton 182 for inputting new meeting attendees/customers or a “new call” pushbutton 184 for receiving new input from the phone call regarding a meeting attendee or customer. This includes providing information from the following, previously described, data input/outputs that includes a customer's or meeting attendee's first name input 154, a customer's or meeting attendee's last name input 156, a customer's or meeting attendee's home phone number input 158, a customer's or meeting attendee's other phone number input 160, a customer's or meeting attendee's facsimile number input 162, a customer's or meeting attendee's e-mail address input 164, a customer's or meeting attendee's first address line input 166, a customer's or meeting attendee's second address line input 168, a customer's or meeting attendee's city input 170, a customer's or meeting attendee's state drop-down selector input 172, a customer's or meeting attendee's zip code input 174, and a customer's or meeting attendee's facility location name from a drop-down selector input 176, which may include other identifying information including the state and the city for the facility.

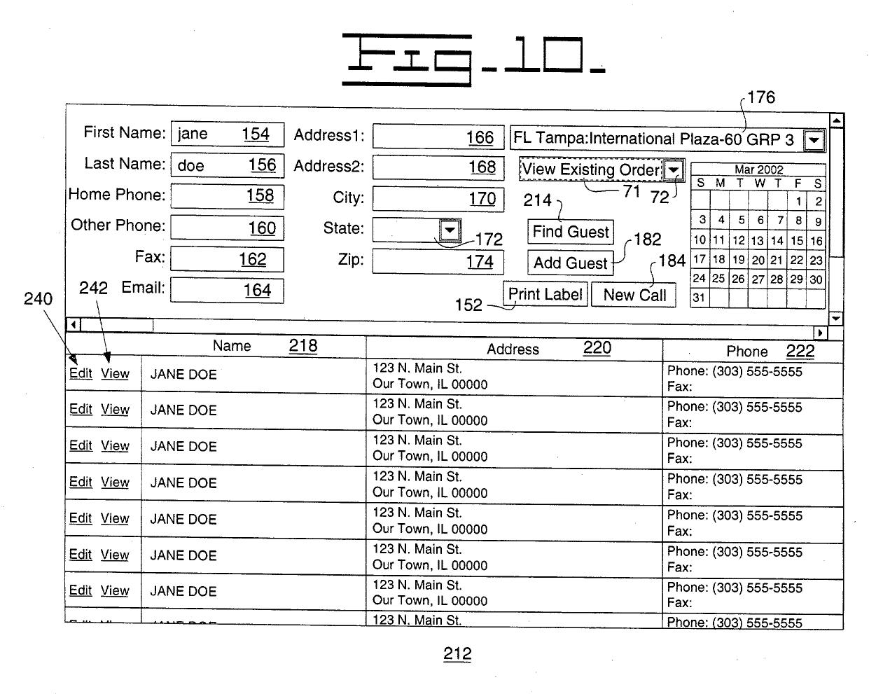

The fifth function in the system management interface 14 is to view details of an existing order of products or services <200>, as shown in FIG. 2. As also shown on the exemplary graphical interface screen display 202, illustrated in FIG. 9, this selection of the “view existing” function from a drop-down selector input 72, then reveals information regarding a specific order (not shown). In this case, if after a predetermined time, the session will timeout requiring the re-inputting of the user name 204, password 206 with a login pushbutton 208.

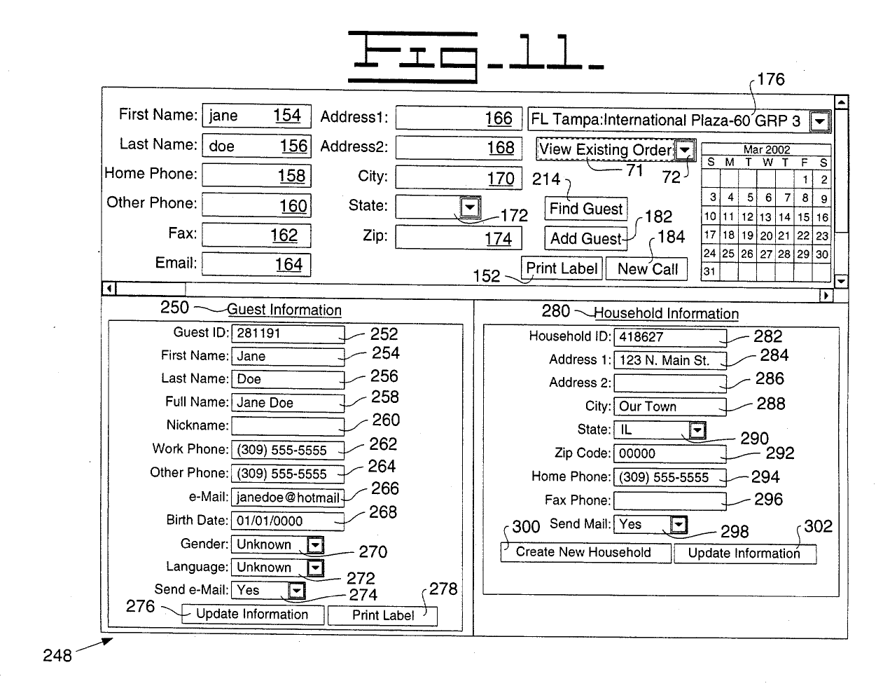

The sixth function in the system management interface 14 is an input function <210> that allows a user, e.g., employee to be able to search for a meeting attendee or customer, as shown in FIG. 2. Also, as shown on the exemplary graphical interface screen display 212 shown in FIG. 10, this is accomplished with a “find guest” pushbutton 214 to find a specific meeting attendee or customer on the system of the present invention. Therefore, any information provided in the previously described data inputs that are shown on FIG. 9 can be searched independently or together to search for a particular meeting attendee or customer. This includes, but is not limited to, a customer's or meeting attendee's first name input 154. Preferably, a customer's or meeting attendee's e-mail address can be searched through input 164. Moreover, other input can be searched including a customer's or meeting attendee's first address line input 166, a customer's or meeting attendee's second address line input 168, a customer's or meeting attendee's city input 170, a customer's or meeting attendee's zip code input 174.

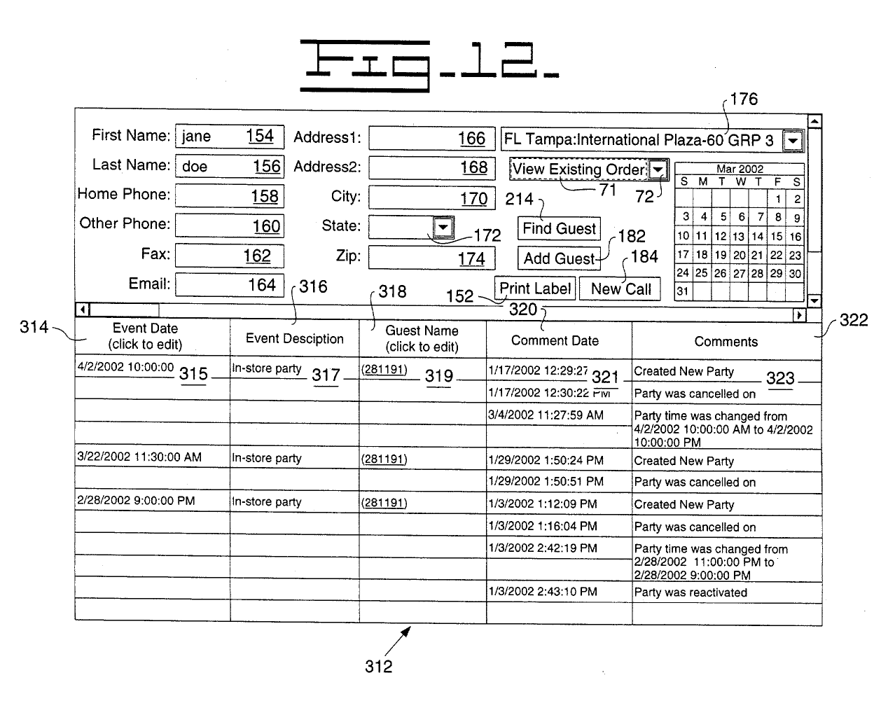

The output provided by the search is in column form is generally indicated by the seventh function <230> on FIG. 2. Also, as shown on the exemplary graphical interface screen that is generally indicated by numeral 212 in FIG. 10. This includes a column for the meeting attendee's or customer's name 218, a column for the meeting attendee's or customer's full address 220, and a column for the meeting attendee's or customer's phone and facsimile number 222. Each meeting attendee or customer has an edit hyperlink 240 or a view hyperlink 242 that directs the user to the eighth and ninth functions <244> and <246>, respectively, which allows the user to either edit or view the meeting attendee's or customer's information and edit or view the meeting attendee's or customer's household information. When the edit hyperlink 240 is selected, the user is directed to the exemplary graphical interface screen that is generally indicated by numeral 248 in FIG. 11.

Under the heading of “Guest Information” 250, where a guest is either a customer or meeting attendee, is an output for an identification number 252, an input for a first name of the meeting attendee or customer 254, an input for a last name of the meeting attendee or customer 256, an input for a full name of the meeting attendee or customer 258, an input for a nickname of the meeting attendee or customer 260, an input for a work phone of the meeting attendee or customer 262, an input for another phone number of the meeting attendee or customer 264, an input for an e-mail address of the meeting attendee or customer 266, an input for a birth date of the meeting attendee or customer 268, a drop-down selector input of the gender of the meeting attendee or customer 270, a drop-down selector input for the language of the meeting attendee or customer 272, a drop-down selector input for whether or not an e-mail can be sent to this meeting attendee or customer 274, and a pushbutton input to update information 276 and a pushbutton input to print a label 278 directed to this meeting attendee or customer.

Under the heading of “household information” 280 is an output for an identification number 282, an input for a first line of an address for the household of the meeting attendee or customer 284, an input for a second line of an address for the household of the meeting attendee or customer 286, an input for a city for the household of the meeting attendee or customer 288, a drop-down selector input for the state for the household of the meeting attendee or customer 290, an input for a zip code for the household of the meeting attendee or customer 292, an input for a home phone for the household of the meeting attendee or customer 294, an input for a facsimile number for a household of the meeting attendee or customer 296, a drop-down selector input for whether or not mail can be sent to this guest or customer 298, a pushbutton input to create a new household for a meeting attendee or customer 300 and a pushbutton input to update household information for a meeting attendee or customer 302.

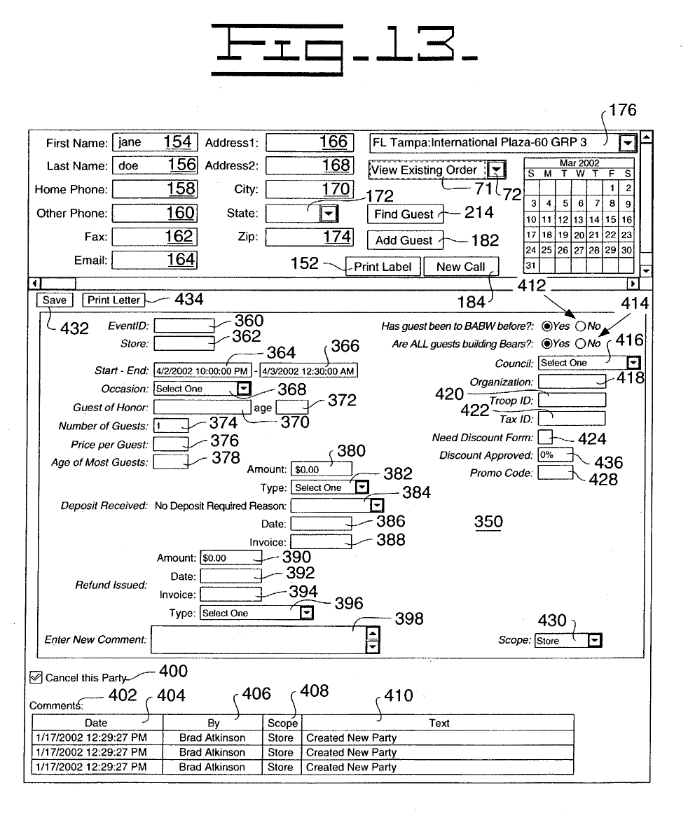

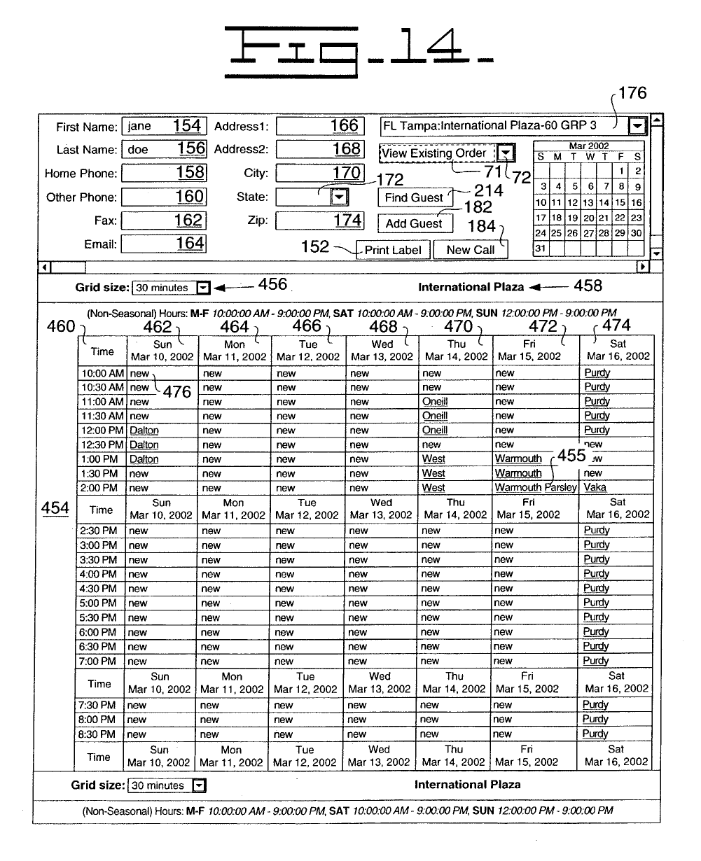

Also, as shown on the exemplary graphical interface screen that is generally indicated by numeral 216 in FIG. 10, the view hyperlink 242 also directs the user to a tenth function <310> on FIG. 2, which is a listing of all scheduled meetings or events for that particular meeting attendee or customer, which is generally indicated by numeral 312 on FIG. 12. There is a first column that includes a date and time for the meeting or event, e.g., party, 314 where every entry, e.g., specific meeting or event date and time such as that indicated by the numeral 315, is a hyperlink to an edit screen that is generally indicated by numeral 350 on FIG. 13. The second column on the exemplary graphical interface screen 312, illustrated in FIG. 12, is a description of the meeting 316, e.g., “in-store party” indicated by numeral 317. The third column on the exemplary graphical interface screen 318, illustrated in FIG. 12, is a representation, e.g., numerical, of a meeting attendee or customer indicated by numeral 319. The fourth column on the exemplary graphical interface screen 312, illustrated in FIG. 12, is the date and time that comments regarding a meeting, e.g., party, are inputted into the system 320, e.g., “Jan. 27, 2002, 12:29:27 PM”, which is indicated by numeral 321. Finally, the fifth column on the exemplary graphical interface screen 212, illustrated in FIG. 12, is for comments regarding a particular meeting, e.g., party, 322, e.g., “Created New Party 323.” Examples of comments for the meeting can include “cancellation”, “time changes”, “reactivation”, and so forth.

Under the first column that includes a date and time for the meeting 314 where every entry, e.g., the entry indicated by numeral 315, is a hyperlink to an edit screen that is generally indicated by numeral 350 on FIG. 13, which is the eleventh function <351> on FIG. 2. There is an output for an identification number for a particular meeting, e.g., party, 360, an output number for a facility, e.g., store identification information, e.g., number, 362, an input for a starting date and time 364, an input for an ending date and time 366, a drop-down selector input for the occasion 368, an input for the status of a particular meeting attendee or customer, e.g., guest of honor, 370, an input for the age of the selected meeting attendee or customer, e.g., guest of honor, 372, an input for the number of meeting attendees or customers, e.g., guests, 374, an input for the price per meeting attendee or customer, e.g., guest, 376, an input for an average age for most of the meeting attendees or customers, e.g., guests, 378.

For the received deposit, the amount that will be spent on the meeting is provided in input 380, a drop-down selector input is provided for the type of payment 382, a drop-down selector input is provided for the reason as to why a deposit is not required 384, an input for the date of an invoice for a deposit 386 is provided as well as an input for the number of an invoice for the deposit 388.

For an actual refund that is issued, the amount of the refund is provided in input 390, the date the refund is issued is provided in input 392, the number of the invoice for the refund is provided in input 394 and the type of refund that is issued is provided in input 396. There is a scroll-down data field input 398 for any new comments that are associated with the meeting or a refund of a deposit.

There is a click-on input 400 to cancel the meeting, e.g., party. A listing of comments associated with a particular meeting, e.g., party, 402 is displayed, which includes a first column for the date and time the comment is entered 404, a second column for the name of the user, e.g., employee, that entered the comment 406, a third column for the scope of the comment 408, e.g., facility or store, and a fourth column that is the text of the comment 410.

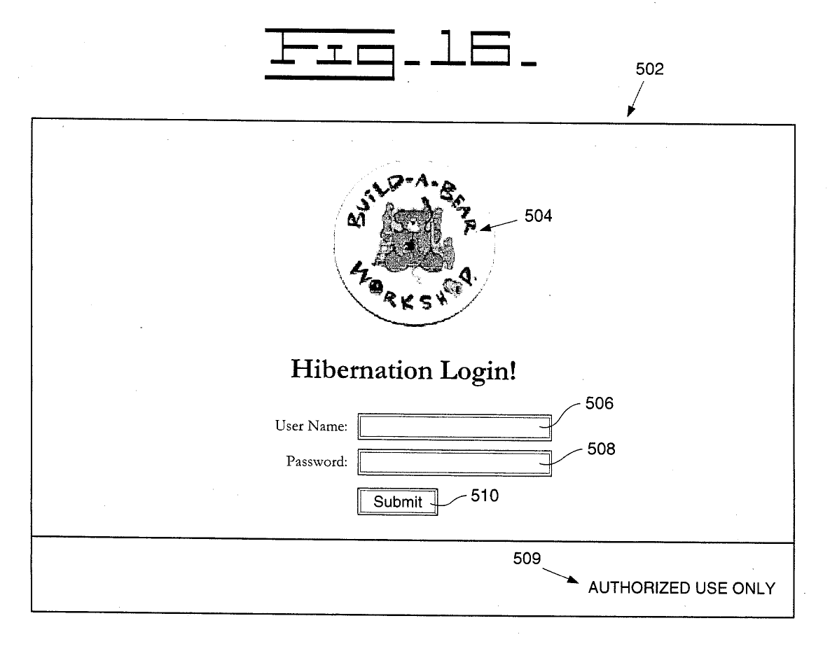

The right side of the edit screen that is generally indicated by numeral 350 on FIG. 13 includes a click-on indication as to whether that person has attended a meeting in the past or merely went to a facility without attending a meeting 412, a click-on indication as to whether all meeting attendees or customers would be utilizing a product or service 414. There is a drop-down selector input for a group that the meeting attendee or customer is a member 416 as well as input for a particular organization that the meeting attendee or customer is a member 418 and an input for an identification number input 420. Moreover, there is an input for a tax identification number for the specific organization 422. There is a click-on input as to whether a discount form 424 is required, an input for the percentage of discount that has been approved 426 and an input for a promotional code 428. There is a drop-down selector input 430 to indicate the origination of the request, e.g., store, for the meeting 430. There is a pushbutton 432 that saves the information on this edit screen 350. In addition, there is pushbutton 434 that allows the user to printout a confirmation letter. As shown on the exemplary graphical interface screen that is generally indicated by numeral 480 in FIG. 15, the user can generate form letters to cancel or confirm meetings as shown by the twelfth function <482> on FIG. 2.

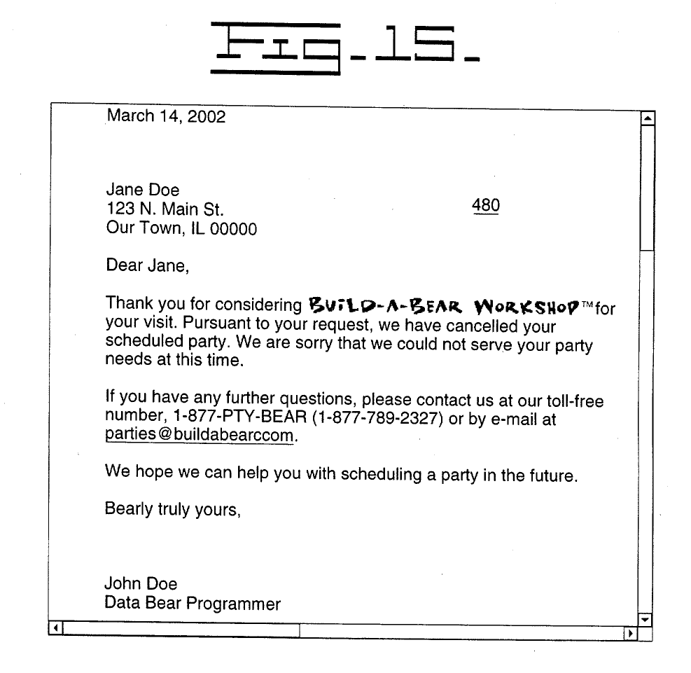

Also, from the main interface screen <40>, as shown in FIG. 2, the system user can view meetings by facility, e.g., store through the thirteenth function <450> and this same screen can allow the user to add a new meeting through the fourteenth function <452> by clicking on an open time. The exemplary graphical interface screen display is shown in FIG. 14 and is generally indicated by numeral 454, this includes a drop-down selector input for the time period or portion of the day for each meeting displayed 456, and an output for the specific facility name 458, e.g., store, that is displayed. There is a column for the time 460, and a column for each day of the week Sunday 462, Monday 464, Tuesday 466, Wednesday 468, Thursday 470, Friday 472 and Saturday 474, respectively. By clicking on an open time that has the word “new” such as that indicated by numeral 476, a new meeting can be inputted by the user, e.g., employee. As indicated by the meeting listed by numeral 455, double booking of a facility may be permitted as an optional feature.

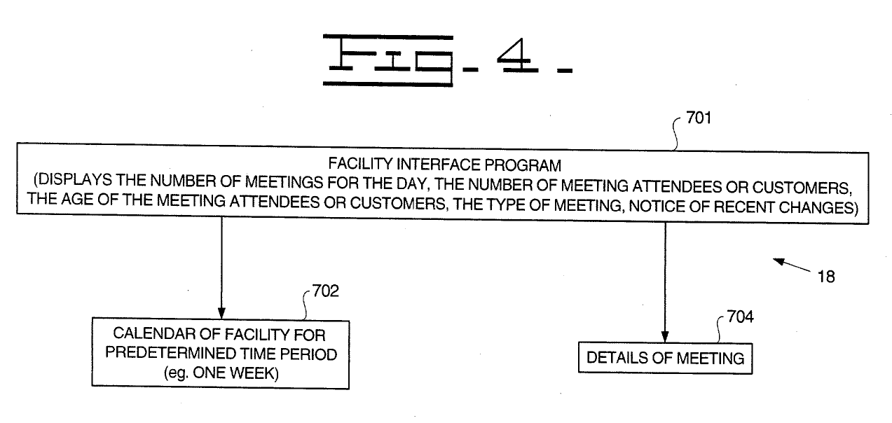

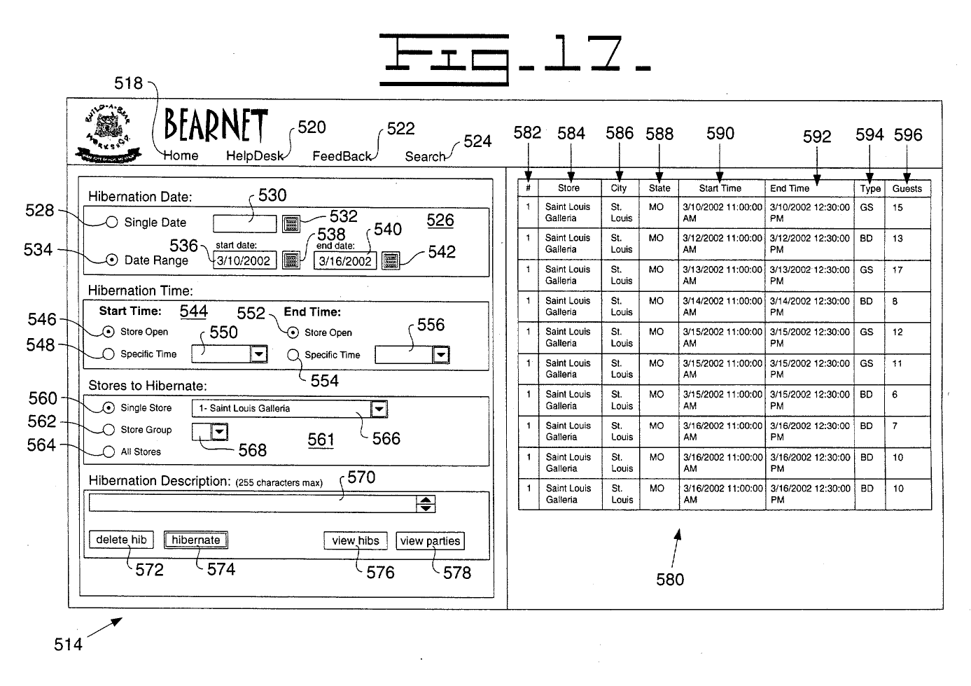

Referring now to FIG. 3, the first step in reserving a facility, which is otherwise described as a time blocking function, e.g., “hibernation”, for a meeting, e.g., party, is for the user, e.g., administrator, to login into the facility reservation interface program 16 of the present invention <500>, as is also shown in FIG. 1. As shown on the exemplary graphical interface screen display for the login function shown in FIG. 16 and generally indicated by numeral 502, this includes an organizational logo 504, an input for the employee's or user's name 506, an input for the employee's or user's password 508, and a pushbutton 510 for submitting the employee's or user's name and the employee's or user's password to this software function of the system associated with the present invention. There may be an optional disclaimer to emphasize the fact that the facility reservation interface program 16 is for “Authorized Use Only” as indicated by numeral 509.

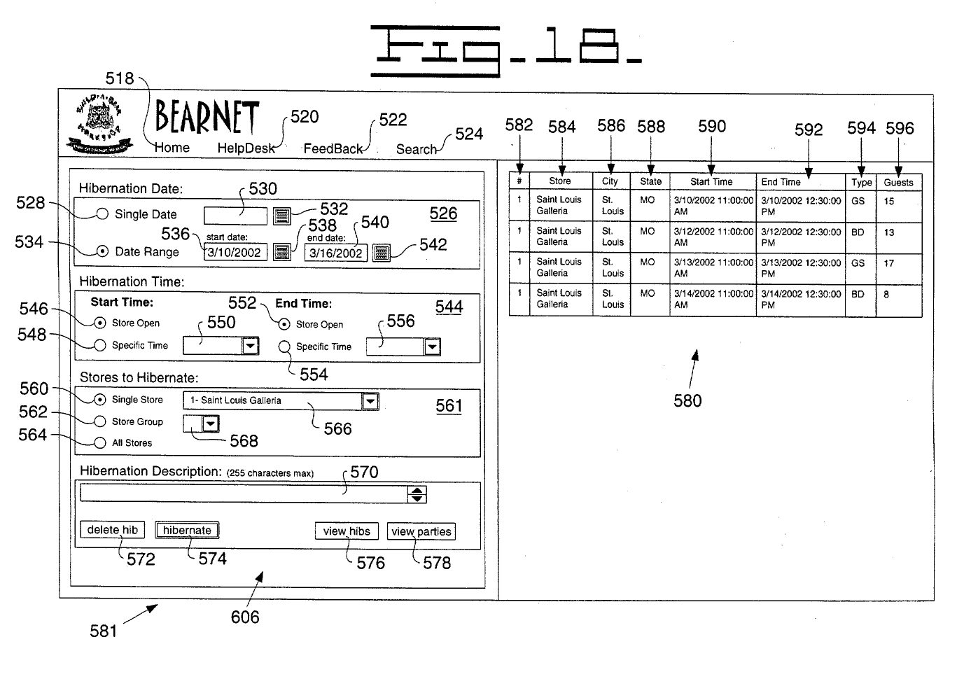

The second step in the time blocking function for a meeting, e.g., hibernation, interface program 16 is a main interface screen <512> as shown in FIG. 3. As shown on the exemplary graphical interface screen display in FIG. 17 and generally indicated by numeral 514, this includes an optional organizational logo and trademark 516, a first hyperlink for going to a home page 518, a second hyperlink to going to a “help desk” type of function 520 for assistance with the system of the present invention, a third hyperlink for directing the user, e.g., employee, to a feedback function 522 regarding the system of the present invention and a fourth hyperlink for directing the user, e.g., employee, to a search function 524 of the system of the present invention.

There is an output for a date for a meeting that is generally indicated by numeral 526. There is a click-on input 528 to indicate that a single date is desired to be reserved (blocked-out, e.g., hibernation) for a meeting as well as a date input 530 for typing in a particular date or a calendar input function 532 that converts a selected date on a graphical representation of a calendar to a date that is automatically fed into the date input 530. There is a click-on input 534 to indicate that a range of dates are desired to be reserved (blocked-out, e.g., hibernation) for meetings as well as a starting date input 536 for typing in a particular starting date or a calendar input function 538 that converts a selected date on a graphical representation of a calendar to a date that is automatically fed into the starting date input 536 as well as a ending date input 540 for typing in a particular ending date or a calendar input function 542 that converts a selected date on a graphical representation of a calendar to a date that is automatically fed into the ending date input 540.

There is an output for a time to reserve (block-out, e.g., hibernate) for a meeting that is generally indicated by numeral 544. There is a click-on input 546 to indicate the earliest operating start time when the facility, e.g., store can be reserved for a meeting, e.g. party, and by a click-on input 548 for a specific time when a facility, e.g., store is reserved (blocked-out, e.g., hibernation). There is a drop-down selector input 550 for inputting this specific starting time to indicate when the facility, e.g., store is reserved. There is a click-on input 552 to indicate the closing time or latest time a facility, e.g., store can be reserved for a meeting or a click-on input 554 for a specific time when a facility, e.g., store can no longer be reserved or “blocked-out.” There is a drop-down selector input 556 for inputting this specific ending time when a facility, e.g., store, is no longer reserved or blocked-out, e.g. hibernating.

There is an output to indicate the specific facilities, e.g., stores, that are to be blocked out or reserved, e.g. hibernating, for a meeting, e.g., party, that is generally indicated by numeral 561. There is a first click-on input 560 to indicate that a single facility, e.g., store, is to be blocked-out or reserved, e.g., hibernating. There is a drop-down selector input 566 for finding a listing of facilities, e.g., stores. There is a second click-on input 562 for reserving or “blocking-out”, e.g., hibernating, a group of facilities, e.g., stores, with an associated drop-down selector input 568 that identifies specific groupings of facilities, e.g., stores. Finally, there is a third click-on input 564 that allows the user to reserve or “block-out” all of the facilities simultaneously. There is an input 570 for providing a description involving the reasons for the reservation or blocking-out, e.g., “hibernation”, of the facility, e.g., store.

As shown on the exemplary graphical interface screen display shown in FIG. 17 and generally indicated by numeral 580, there is a listing of all meetings, e.g., parties, for the selected dates, times and facilities, e.g., stores, based on a user query which is the function described in the third process step <600>, on FIG. 3, based on clicking a “view parties” pushbutton 578 as shown on FIG. 17. This output listing 580 is arranged in columns including a facility, e.g., store, number 582, a facility, e.g., store, name 584, a city where the facility, e.g., store, is located 586, a state where the facility, e.g., store, is located 588, the start time for the meeting, e.g., party, 590, the end time for the meeting, e.g., party, 592, the type of meeting, e.g., party, 594 and the number of guests or attendees for the meeting, e.g., party 596.

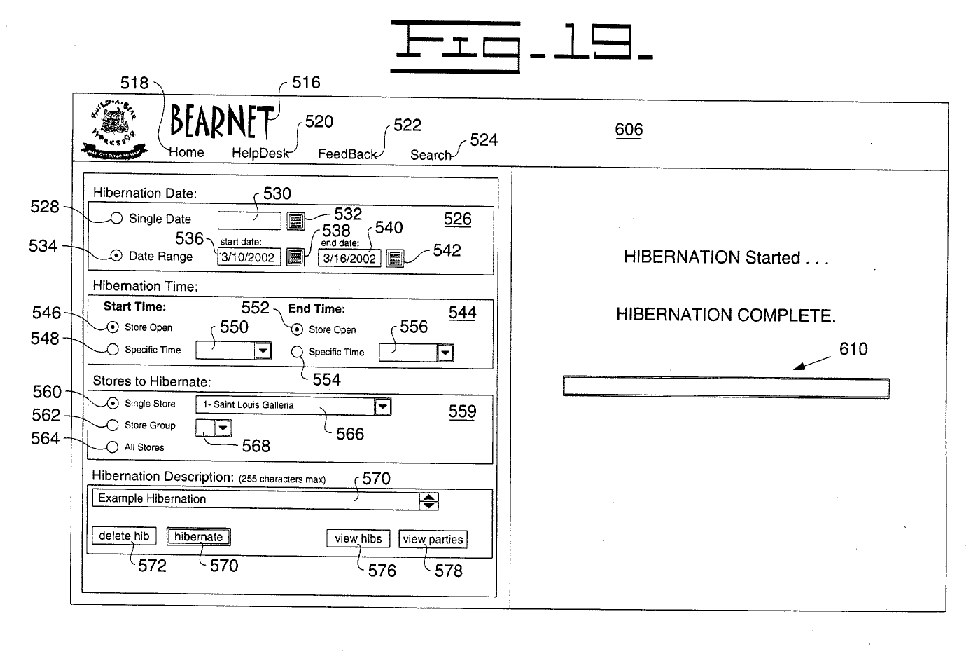

As shown on the exemplary graphical interface screen display shown in FIG. 18 and generally indicated by numeral 581, there is a listing of all reserved times or blocked-out time periods, e.g., hibernations, for the selected dates, times and facilities, e.g., stores based on a user query which is the function described in the fourth process step <602>, on FIG. 3, based on clicking a “view hibs” (view hibernations otherwise known as block-outs or reservations) pushbutton 576 as shown on FIG. 18. This listing 580 is arranged in columns including a number for a facility, e.g., store, 582, a name for a facility, e.g., store, 584, a city where the facility, e.g., store, is located 586, a state where the facility, e.g., store, is located 588, the start time for the meeting, e.g., party, 590, the end time for the meeting, e.g., party, 592, the type of meeting, e.g., party 594 and the number of guests or attendees for the meeting, e.g., party 596. If the “view hibs” (view hibernations otherwise known as block-outs or reservations) pushbutton 576 is selected, the number of attendees or guests should equal zero (0). This occurs when the facility, e.g., store, is closed for parties, but open for another purpose, e.g., retail sales.

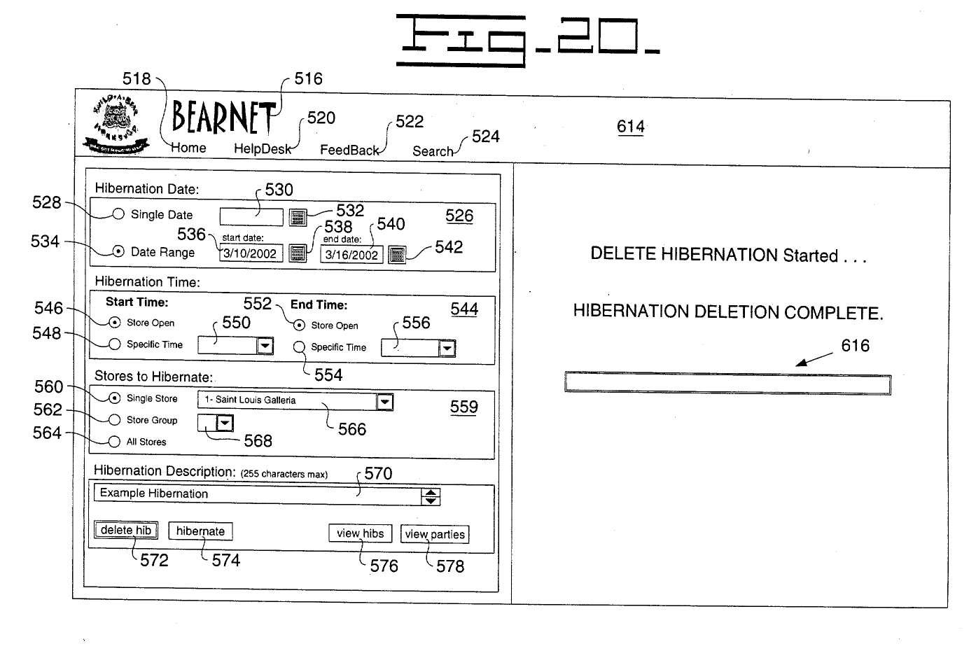

The exemplary graphical interface screen display shown in FIG. 19 that is generally indicated by numeral 606, provides the function for the user to create a reservation or a blocking-out of a facility(s), e.g., store(s) based on a function described in the fifth process step <608>, in FIG. 3, based on clicking a “hibernation” pushbutton 574, as shown on FIG. 19. There is a graphical output indicating that the process for reserving or blocking-out a facility or facilities has commenced and when it is completed 610.

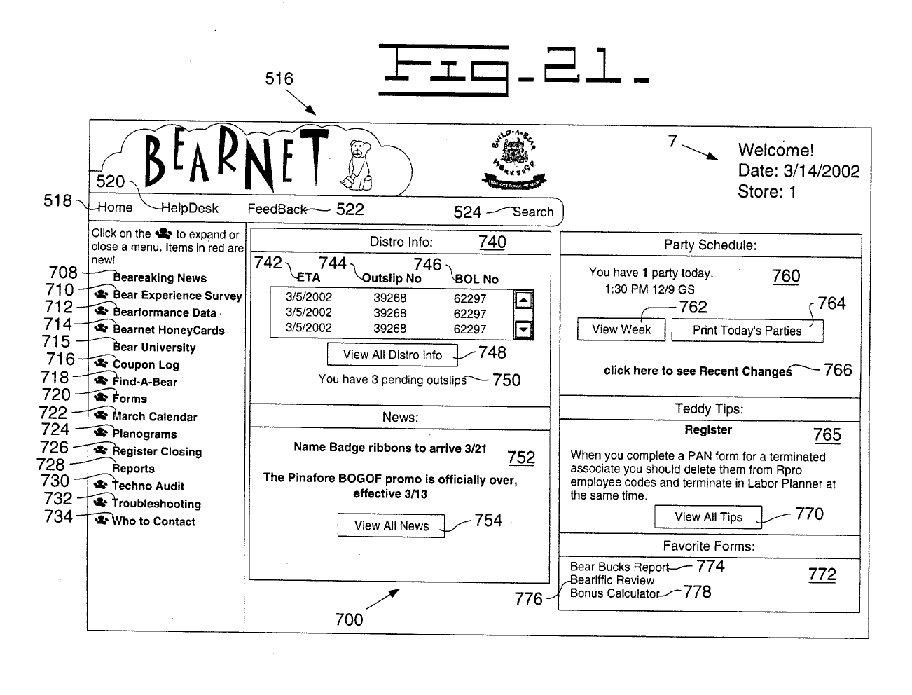

The exemplary graphical interface screen display shown in FIG. 20 that is generally indicated by numeral 614, provides the function for the user to cancel or delete a reservation or a blocking-out of a facility(s), e.g., store(s) based on a function described in the sixth process step <612>, in FIG. 2, based on clicking a “delete hib” or “delete hibernation” pushbutton 572, as shown on FIG. 20. There is a graphical output indicating that the process for removing the reservation or blocking-out of a facility or facilities has commenced and when it is completed 616.

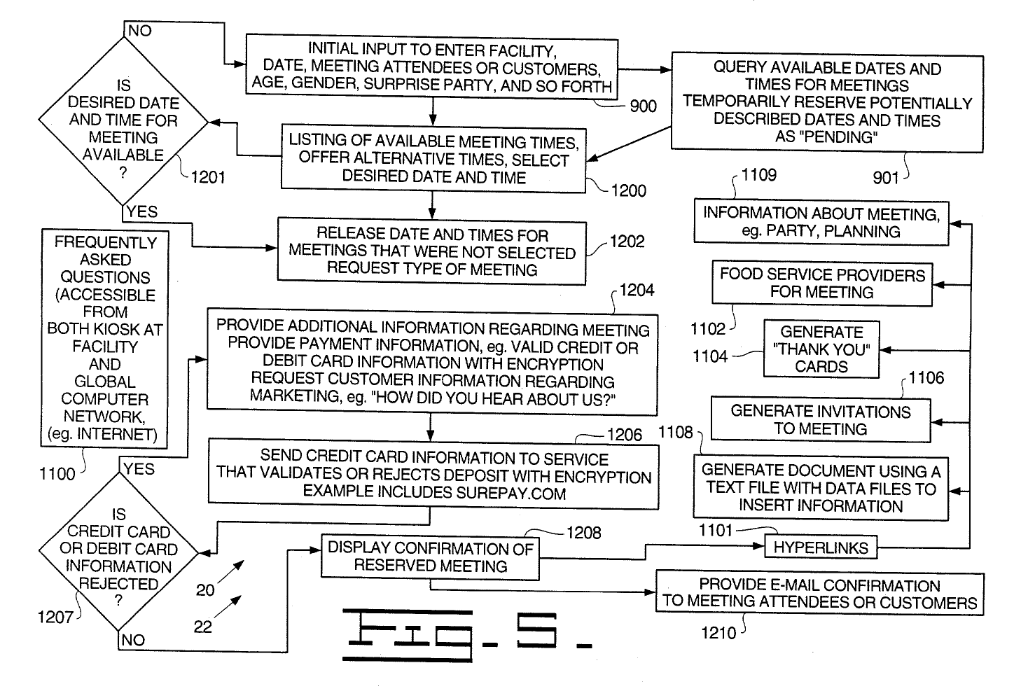

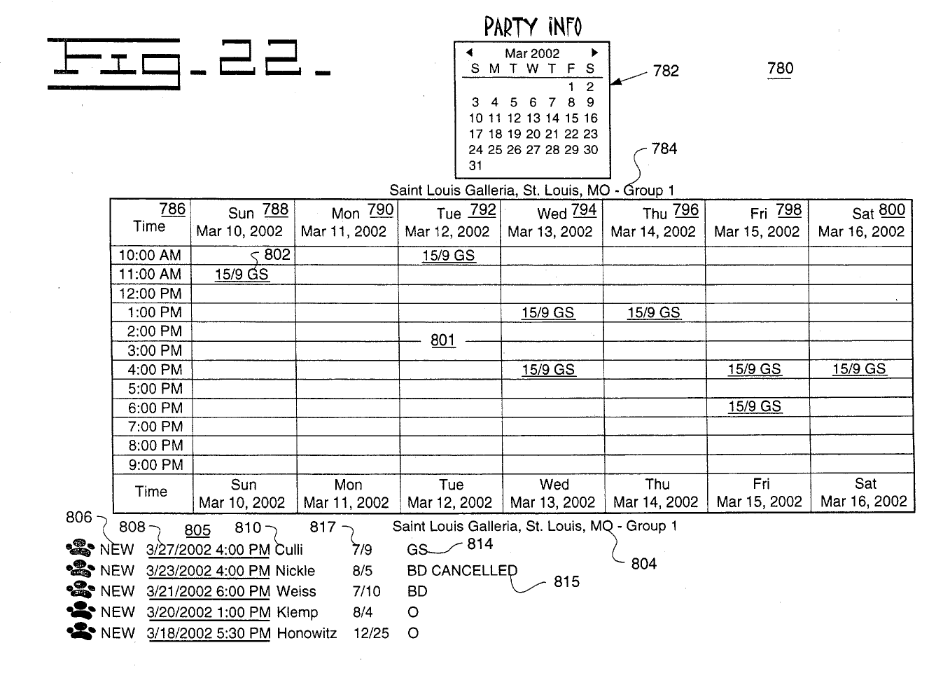

Referring now to FIGS. 1 and 4, an interface utilized by a user at a particular facility, e.g., store, is generally indicated by numeral 18. As shown in FIG. 4 in process step <701> and on the exemplary graphical user interface shown on FIG. 21, the first functional graphical interface screen display allows the user at a particular facility, e.g., store, to be able to obtain pertinent information as to the operation of the facility, e.g., store, as generally indicated by numeral 700. As shown on FIG. 21, there is a series of hyperlinks that provide access for the user, e.g., employee, to a variety of informational features including, but not limited to, organizational news 708, a customer experience survey 710, organizational performance data 712, communication cards to other users, e.g., employees 714, special product listings 715, coupon utilization 716, product or service locator 718, common or preferred forms utilized by the organization associated with the system of the present invention 720, calendar of meetings, e.g., parties, for the organization 722, planograms or graphical representations of organizational data 724, cash register closing information and monetary data 726, organizational reports 728, technical auditing functions 730, a system troubleshooting function 732 associated with the system of the present invention and an user, e.g., employee, contact for assistance 734.

An illustrative, but nonlimiting, feature found on the exemplary graphical interface screen display 700 shown on FIG. 21, includes product distribution information that is generally indicated by numeral 740. This includes an estimated time of arrival for a shipment of product(s) or service(s) 742, an outslip number associated with that particular shipment 744 and a bill of lading number 746 that is also associated with that particular shipment. There is a pushbutton 748 that allows the user, e.g., employee, to view all distribution information with an output for all pending outslips that the facility user is tracking 750.

Another illustrative, but nonlimiting, feature found on the exemplary graphical interface screen display 700 shown on FIG. 21, allows the user, e.g., employee, at a particular facility, e.g., store, to view pertinent organizational news 752. This includes a pushbutton 754 that allows the user to view all organizational news associated with the organization for the system of the present invention.

Yet another illustrative, but nonlimiting, feature found on the exemplary graphical interface screen display 700 shown on FIG. 21, allows the user at a particular facility, e.g., store, to view all meetings, e.g., parties, scheduled at a particular facility 760. There is a first pushbutton that allows the user to view all meetings, e.g., parties, scheduled for a predetermined time period, e.g., the current week, 762 and second pushbutton to print-out to view all meetings, e.g., parties, scheduled for another predetermined time period, e.g., today, 764. There is a hyperlink 766 to view all recent changes to the currently scheduled meetings, e.g., parties.

Still another illustrative, but nonlimiting, feature found on the exemplary graphical interface screen display 700 shown on FIG. 21, allows the user at a particular facility, e.g., store, to view an operational hint or receive advice utilized in operating the facility, e.g., store, 768. There is a pushbutton 770 that allows the user to view all operational hints located on the system associated with the present invention.

It is another illustrative, but nonlimiting, feature found on the exemplary graphical interface screen display 700 shown on FIG. 21, allows the user at a particular facility, e.g., store, to access a variety of forms 772 that are listed in a series of hyperlinks. Illustrative, but nonlimiting, examples include gift certificate reports 774, employee reviews 776, employee bonus calculations 778, and so forth.

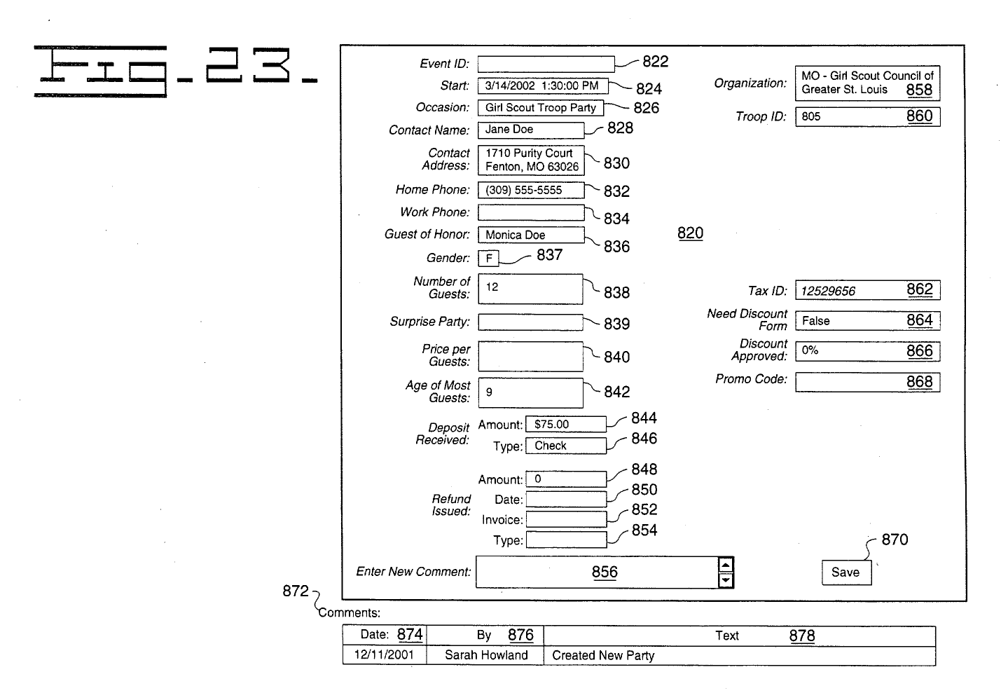

Upon clicking of the pushbutton 762 takes the user to the screen that is generally indicated by numeral 780 on FIG. 22, which is also indicated by second process step <702> on FIG. 4. On the exemplary graphical interface screen display 780, as shown in FIG. 22, there is a graphical representation of a calendar for a predetermined time period, e.g., month 782. Underneath this calendar 782 is a heading 784 that lists a particular facility name, e.g., store. This may also include the location and/or grouping for the facility. There is a table of scheduled meetings, e.g. parties, which is generally indicated by numeral 801. From left to right, there is a column for the time in predetermined increments or portions of the day 786, e.g., one (1) hour, and the days of the week including Sunday 788, Monday 790, Tuesday 792, Wednesday 794, Thursday 796, Friday 798 and Saturday 800. If meetings, e.g., parties, are scheduled on a particular day at a particular time period, there is a hyperlink, e.g., 802, which provides some basic information and then allows the user, e.g., employee, to hyperlink to obtain additional information. This basic information may include the number of attendees, average age of attendees, type of meeting, e.g., party. Under the table of scheduled meetings 801, there is a second heading 804 that also, like the first heading 784, lists the particular facility, e.g., store. At the bottom of this exemplary graphical interface screen display 780 is a listing of new meetings, e.g., parties, that have been recently scheduled that is generally indicated by numeral 805. There is a column with an indication and logo that the scheduled meeting, e.g., party, is newly scheduled 806, a column of hyperlinks that lists the date and time for each scheduled meeting, e.g., party, 808 that directs the user, e.g., employee to additional information, a column for the primary attendee or customer attending the scheduled meeting, e.g., party, 810, a column for information regarding the scheduled meeting, e.g., party, such as the number of people attending as well as average age of the attendees 817, and a column for the type of event or meeting, e.g., birthday party, 814. There is an additional column 815 to alert the user, e.g., employee, that an event or meeting is cancelled 815.

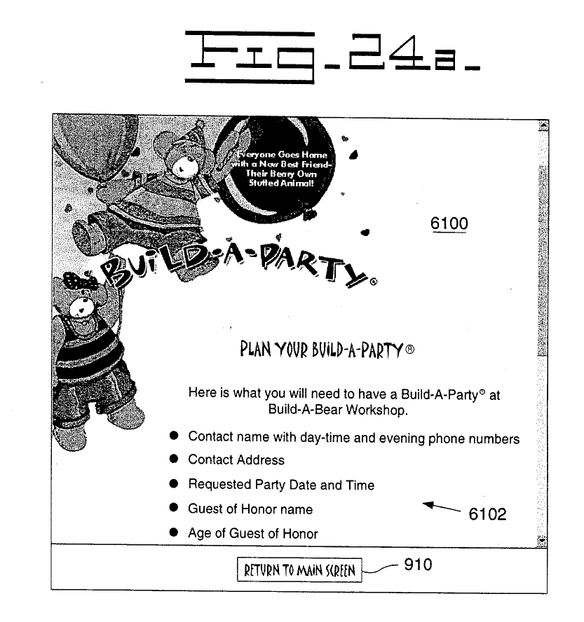

When any of the numerous hyperlinks for additional information, e.g., 802, 808 and so forth, are clicked, the system directs the user to detailed information regarding a scheduled meeting, e.g., party, such as that generally indicated by numeral 820 on the exemplary graphical user interface shown on FIG. 23 as well as the fourth process step <704> on FIG. 4.

Examples of the type of information found on this additional information screen 820 can include an identification number of the particular scheduled meeting, e.g., party, 822, the starting date and time for the scheduled meeting, e.g., date, 824, the occasion for the particular scheduled meeting, e.g., party, 826, the contact name for the particular scheduled meeting, e.g., name, 828, the contact's address for the particular scheduled meeting, e.g., party, 830, the home phone number for the contact for the particular scheduled meeting, e.g., party, 832, the work phone number for the contact for the particular scheduled meeting, e.g., party, 834, the designated guest of honor for the particular scheduled meeting, e.g., party, 836, the gender of the guest of honor for the meeting, e.g., party 837, an indication as to whether the meeting, e.g., party, is a surprise 839, the number of guests for the particular scheduled meeting, e.g., party, 838, the price per guest for the particular scheduled meeting, e.g., party, 840, the age of most guests for the particular scheduled meeting, e.g., party, 842, the amount of deposit for the scheduled meeting, e.g., party, 844 and the payment type for deposit, 846 associated with the particular scheduled meeting, e.g., party, the amount of refund issued 848, the date the refund was issued 850, an invoice number associated with a refund 852, the type of refund provided 854, a data entry field for a new comment 856, the name of the organization having the particular scheduled meeting, e.g., party, 858, the identification number for the organization having the particular scheduled meeting, e.g., party, 860, the tax identification number for the organization having the particular scheduled meeting, e.g., party, 862, an output as to whether a discount form is needed 864, an output as to a percentage of discount that is approved by the organization associated with the system of the present invention 866 and an output for a promotional code 868.

There is a pushbutton input 870 to save any newly inputted information. Also, there is a listing of comments 872 on the bottom of this exemplary graphical user interface screen 820. This includes a column for the date 874, the user, e.g., employee, who created the comment 876 and the text of the comment 878.

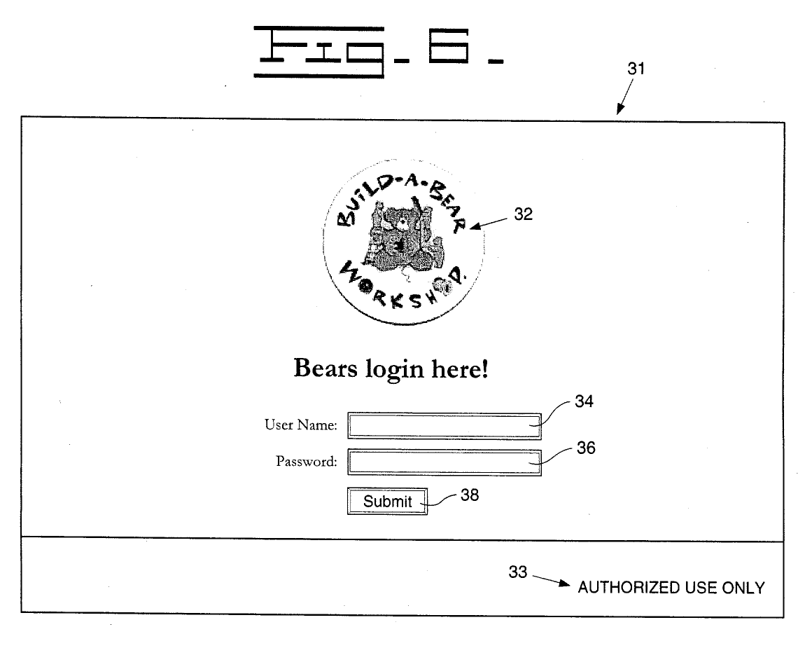

Referring now to FIG. 5, the actual scheduling of a meeting, e.g., party, by a customer can be accomplished by at least two, illustrative but nonlimiting methods. The first method is to make the reservation at a processor located at a kiosk at the facility, e.g., store, which is a software program indicated by numeral 22 on FIG. 1. The second method is through a processor that is electrically connected to global computer network, e.g., Internet, which is a software program indicated by numeral 20 on FIG. 1.

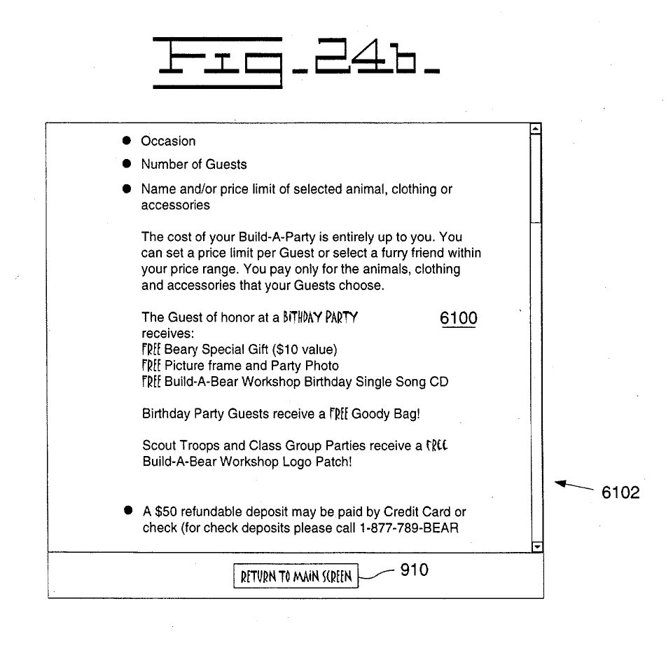

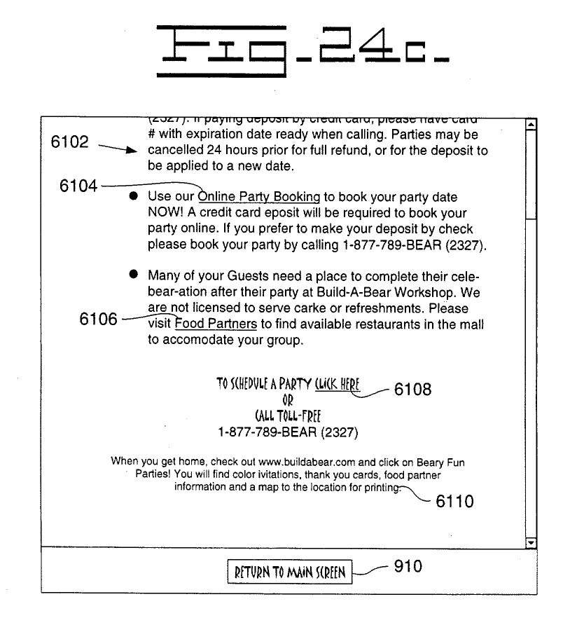

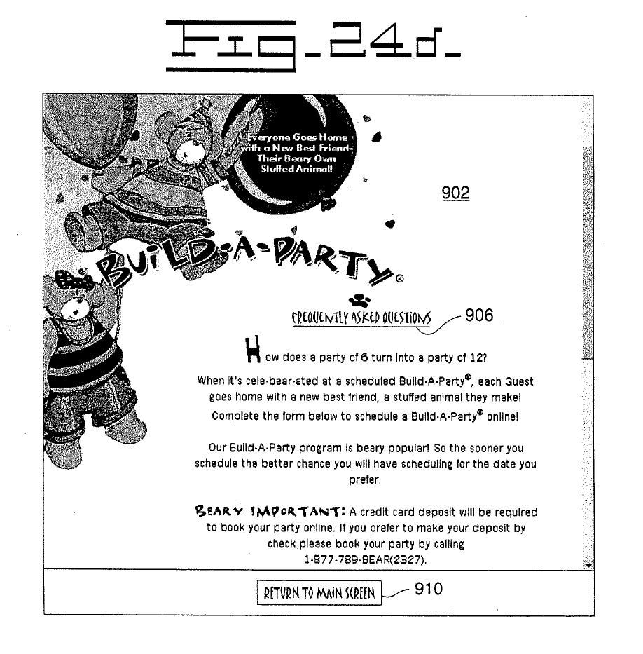

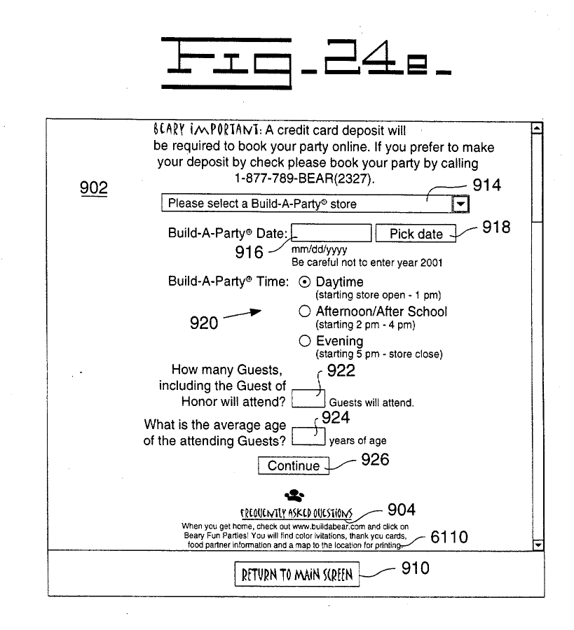

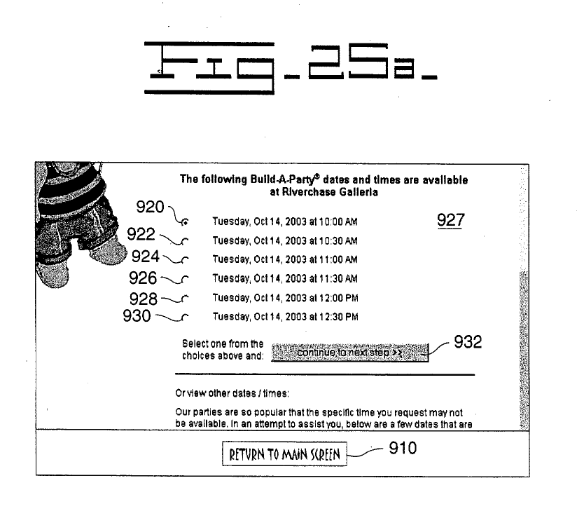

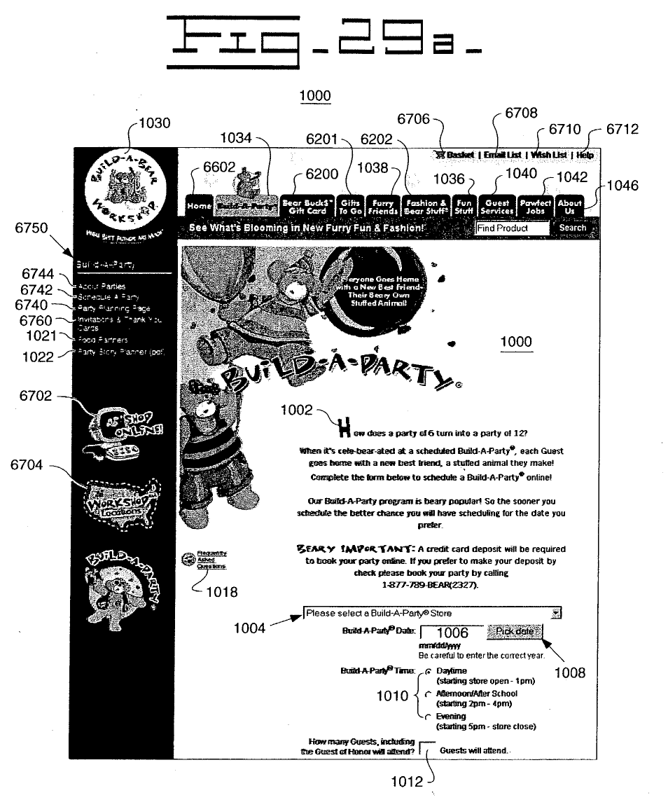

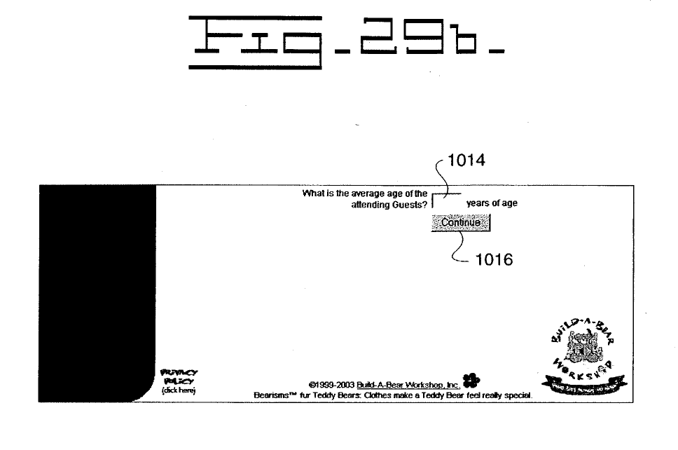

As shown in FIGS. 24A, 24B, 24C, there is first a graphical user interface that is generally indicated by numeral 6100 and provides meeting, e.g., party, background planning information regarding the scheduling of a meeting, e.g., party, 6102. This is also indicated as process step <1109> on FIG. 5. As before, there is the pushbutton 910 that allows the meeting attendee or customer to return to a main graphical user interface. This graphical user interface screen 6100 can also be accessed from hyperlink 6740 on FIG. 29. As shown in FIG. 24C, there is a first hyperlink to schedule a meeting, e.g., party, 6104, a second hyperlink to obtain ancillary services, e.g., food service, for the meeting, e.g., party, 6106. There is also a third hyperlink that also allows the user to schedule a meeting, e.g., party, 6108 and also provides a phone number to accomplish this same task. Again, the feature that may be present is a listing of marketing information that lists the Internet website, e.g., www.buildabear.com, for the organization as well as promotes other services or features provided by the organization 6110.

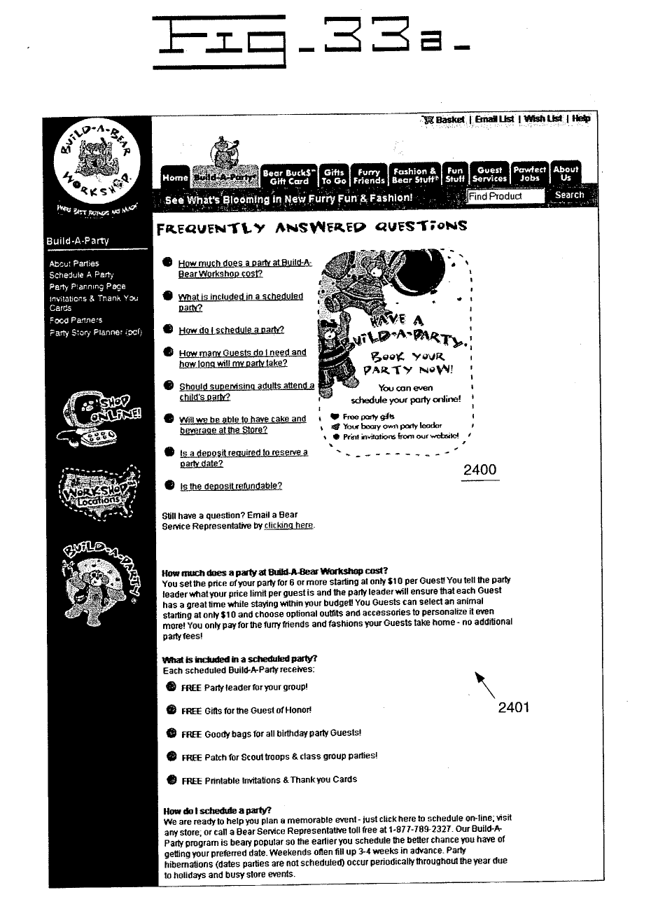

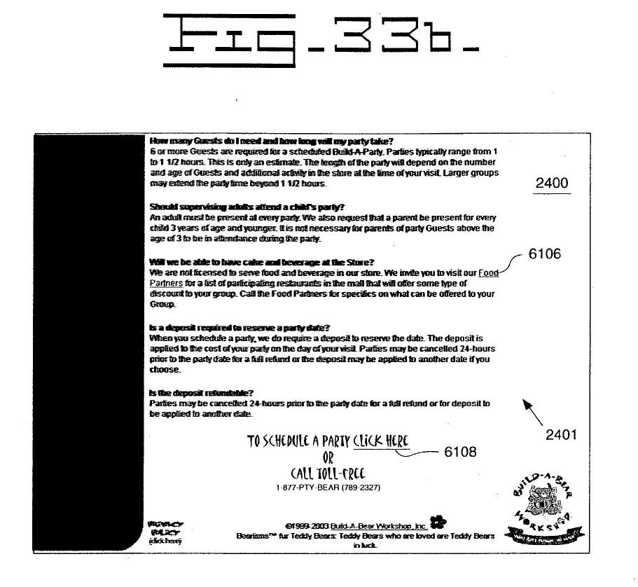

As shown in FIGS. 24D and 24E, the first step in the process for scheduling a meeting, e.g., party by a meeting attendee or customer at a computer located at a kiosk at the facility, e.g., store, as shown in FIG. 5 by process step <900>, is through an exemplary graphical user interface that is generally indicated by numeral 902. There is a hyperlink that directs the meeting attendee or customer to frequently asked questions regarding the system 904. This directs the user to the exemplary graphical interface shown on FIGS. 33A and 33B that is generally indicated by numeral 2400. There is explanatory material regarding the scheduling process provided as output that is indicated by numeral 906. There is a pushbutton 910 that allows the meeting attendee or customer to return to a main graphical user interface.

As shown in FIG. 24E, there is a drop-down selector input 914 for inputting a specific facility, e.g., store. There is an input 916 for providing the desired date for the meeting, e.g., party. There is a pushbutton 918 that allows the customer or meeting attendee to go to a calendar and select a particular date, which is then fed into the date input 916.

As also shown in FIG. 24E, there is a click-on input 920 for desired portions of the day, e.g., daytime, afternoon or evening. There is an input 922 for the number of people who will attend the meeting, e.g., party, and an input 924 for the average age of the people who will attend the meeting, e.g., party. Once this information is inputted, there is a “continue” pushbutton 926 that performs a function <901>, as shown on FIG. 5, to query available meetings, e.g., parties, and reserve at least one date and time for a meeting, e.g., party, as pending as well as directing the meeting attendee or customer to the next stage in the process. Another feature that may be present is a listing of marketing information that lists the Internet website, e.g., www.buildabear.com, for the organization as well as promotes other services or features provided by the organization 6110.

As shown in FIG. 29, there is a graphical user interface that is generally indicated by numeral 6310 that can provide information (general or specific) regarding a potential meeting, e.g., party 6312. This is also indicated by process step <1101> on FIG. 5. Moreover, there is a hyperlink that directs the customer to frequently asked questions 1024, 1018 regarding the system that is indicated by process step <1100> on FIG. 5. This directs the user to the exemplary graphical user interface screen generally indicated by numeral 2400 as shown on FIGS. 33A and 33B to provide the written output information in question and answer format 2401.

In addition, there are a series of hyperlinks that are generally indicated by numeral 1101 on FIG. 5. As shown in FIG. 29, there is a hyperlink 1021 for obtaining food service that is indicated by process step <1102> on FIG. 5, hyperlink 1019 for providing invitations to the meeting, e.g., party, that is indicated by process step <1106> on FIG. 5, a hyperlink 1020 for providing thank-you cards for the meeting, e.g., party, that is indicated by process step <1104> on FIG. 5 and a hyperlink 1022 for planing a story or certificate, e.g., birth certificate, that can be utilized in conjunction with the meeting, e.g., party, by a customer utilizing a global computer network, e.g., Internet that is indicated by process step <1108> on FIG. 5. This story or certificate involves the inputting of data fields that are outputted within text files to provide a customized story or certificate. There is also a hyperlink that directs the user to information regarding the scheduling of a meeting, e.g., party, <1109>, which is shown by graphical user interface 6100 shown on FIGS. 24A, 24B and 24C. This can be in the form of a process checklist for planning a meeting, e.g., party.

Referring now to FIGS. 29A and 29B, the first step in the process for scheduling a meeting, e.g., party, by a meeting attendee or customer at a computer on a global computer network, e.g., Internet, as shown in FIG. 5 by process step <900>, is through an exemplary graphical user interface that is generally indicated by numeral 1000. This process step is virtually identical to that performed by a meeting attendee or customer at a computer located at a kiosk at the facility, e.g., store. There is explanatory material regarding the scheduling process provided as output that is indicated by numeral 1002 that is identical to the explanatory material regarding the scheduling process provided as output that is indicated by numeral 906 in FIG. 24D.

There is a drop-down selector input 1004 for inputting a specific facility, e.g., store that is identical to drop-down selector input 914 shown on FIG. 24E. There is an input 1006 for providing the desired date for the meeting, e.g., party, that is identical to input 916 shown on FIG. 24E. There is a pushbutton 1008 that allows the meeting attendee or customer to go to a calendar and select a particular date, which is then fed into the input 1006 that is identical to pushbutton 918 shown on FIG. 24E. There is a click-on input 1010 for desired portions of the day, e.g., daytime, afternoon or evening, that is identical to click-on input 920 shown on FIG. 24E. There is an input 1012 for the number of people who will attend the meeting, e.g., party, and an input 1014 for the average age of the people who will attend the meeting, e.g., party, that is identical to inputs 922 and 924 shown on FIG. 24E. Once this information is inputted, there is a “continue” pushbutton 1016 that performs a function <901>, as shown on FIG. 5, to query available meetings, e.g., parties, and reserve at least one meeting, e.g., party, as pending as well as directing the user to the next stage in the process that is identical to the “continue” pushbutton 926 shown on FIG. 24E.

In addition, at the top of the exemplary graphical interface screen 1000, shown on FIG. 29A, is a exemplary logo 1030, a hyperlink for purchasing products 1032, a hyperlink 1034 for directs to this same graphical interface screen 1000 for scheduling a meeting, e.g., party, a hyperlink for gift certificates, gift cards and e-mail gift cards 6200, a hyperlink for gift items 6201, a hyperlink for purchasing products 1038, a hyperlink for obtaining complementary products 6202, a hyperlink for ancillary product-related activity, e.g., computer games, screen savers, cards, contests, e-mails and other associated activities, 1036, a hyperlink to looking at all of the customer, e.g., guest services for facilities, e.g. locations, 1040, a hyperlink for all employment opportunities for the organization 1042 associated with the system of the present invention and a hyperlink that directs the user to a graphical user interface (not shown) that provides general information about the organization 1046 associated with the system of the present invention. There is an additional hyperlink 6602 to the organization's home page. There are also a series of hyperlinks that complement the meeting, e.g., party, scheduling functions generally indicated by numeral 6750. There is a first hyperlink 6744 that directs the user to the to the graphical user interface that is generally indicated by numeral 6310 that can provide information (general or specific) regarding a potential meeting, e.g., party 6312, as shown in FIG. 29. A second hyperlink 6742 directs the user to this same graphical interface screen 1000 for scheduling a meeting, e.g., party. A third hyperlink 6740 directs the user to the graphical user interface that is generally indicated by numeral 6100 and provides meeting, e.g., party, background planning information regarding the scheduling of a meeting, e.g., party, 6102, as shown in FIGS. 24A, 24B, and 24C. A fourth hyperlink 6760 for providing invitations to the meeting, e.g., party, that is indicated by process step <1106> on FIG. 5, as well as for providing thank-you cards for the meeting, e.g., party, that is indicated by process step <1104> on FIG. 5. There is a fifth hyperlink 1021 for obtaining foodservice that is indicated by process step <1102> on FIG. 5. A sixth hyperlink 1022 is for planning a story or certificate, e.g., birth certificate, that can be utilized in conjunction with the meeting, e.g., party, by a customer utilizing a global computer network, e.g., Internet that is indicated by process step <1108> on FIG. 5. There are two graphical interface hyperlinks 6702 and 6704 that allow shopping for products or services online and determine the location of facilities, e.g., stores, respectively.

In addition, there are hyperlinks to additional features. This can include a hyperlink 6706 to another graphical user interface screen (not shown) that illustrates to the user what goods or services are purchased in a shopping basket so that a user can see what has been purchased and check-out or keep shopping. Another hyperlink 6710 is an e-mail function that directs the user to a graphical user interface screen (not shown) to either subscribe or unsubscribe to an e-mail list to receive information from the organization associated with the system. Still another hyperlink 6710 is to a “wish list” that directs the user to go to a graphical user interface screen (not shown) that allows user to list desired goods or services so that others can purchase for them as a gift or some other purpose. There is also a “help” hyperlink 6712 that directs the user to a graphical user interface screen (not shown) that allows the user to obtain technical assistance in utilizing the system.

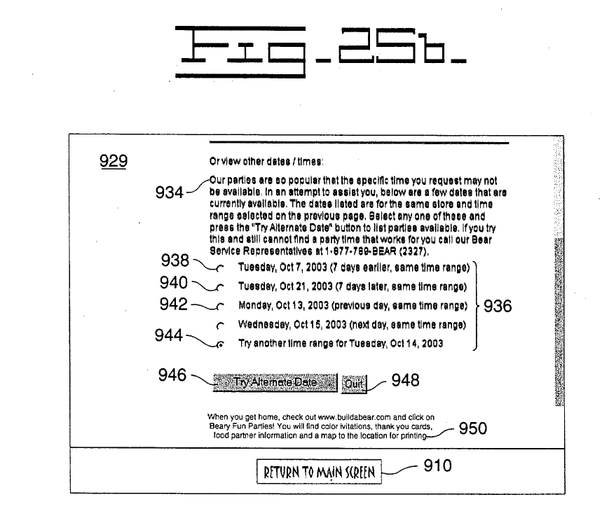

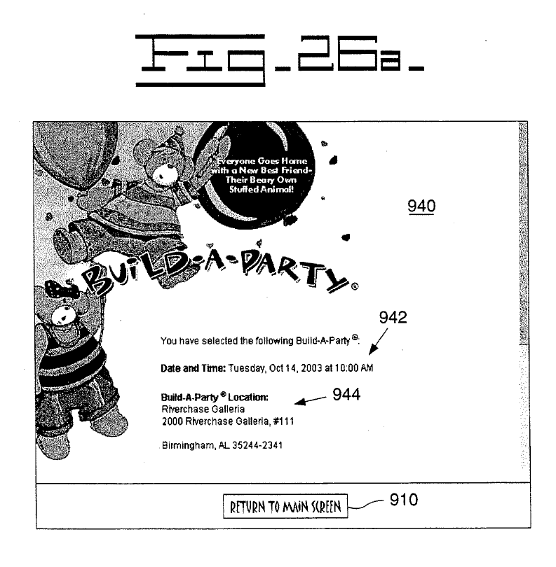

Referring now to FIG. 25A, the next step in the process for a customer at a computer located at a kiosk at the facility, e.g., store, is to schedule a meeting, e.g., party, as shown in FIG. 5 by process step <1200>, is through an exemplary graphical user interface that is generally indicated by numeral 929, is that the available times for the meeting, e.g., party, are displayed on an exemplary graphical user interface that is generally indicated by numeral 910. The desired date and time can be selected through click-in inputs that are shown by numerals 920, 922, 924, 926, 928 and 930, respectively, with the date and time associated with click-on input 932 selected in this illustrative, but nonlimiting, example.

Referring now to FIG. 25B, which is the bottom portion of the same graphical user interface screen shown in FIG. 25A, the desired date and time is unavailable so that the user can view alternative times and dates, as shown by process step <1200> in FIG. 5 is through an exemplary graphical user interface that is generally indicated by numeral 929. There is instructive verbiage regarding this feature that is generally indicated by numeral 934. There are a series of click-on inputs where examples include seven days earlier with the same desired time range 938, the previous day with the same desired time range 940, the next day with the same desired time range 942, and another time range for the same desired day 944. Any of a wide variety of mathematical offsets can be utilized with this feature. There is a pushbutton 946 for continuing the process once an alternative, click-on input is selected and another pushbutton 948 to quit the process. Again, the feature that may be present is a listing of marketing information that lists the Internet website, e.g., www.buildabear.com, for the organization as well as promotes other services or features provided by the organization 950.

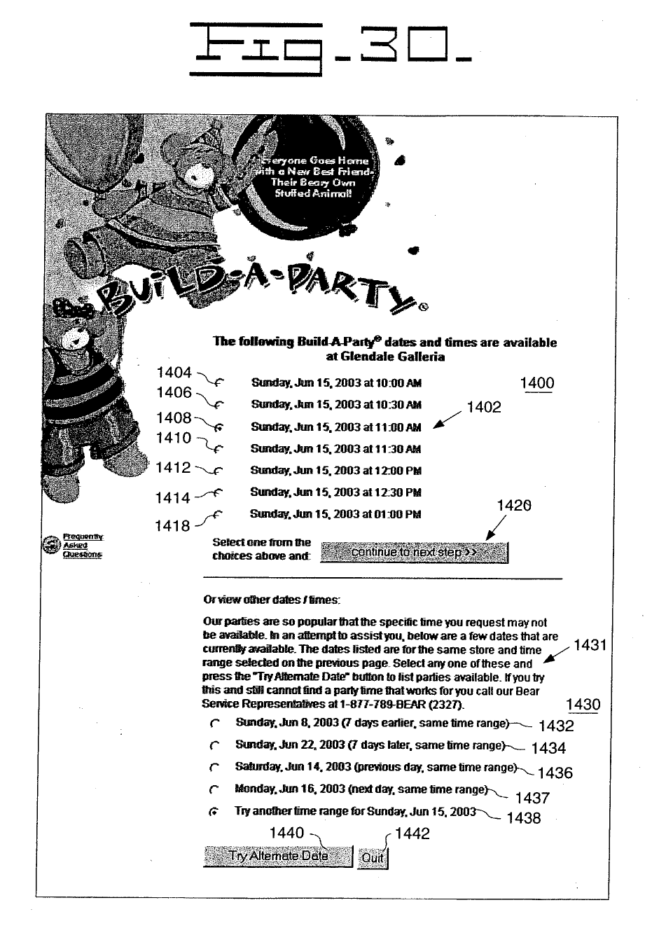

As shown in FIG. 30, the next step in the process for scheduling an meeting, e.g., party, by a customer at a computer on a global computer network, e.g., Internet, as shown in FIG. 5 by process step <1200>, is through an exemplary graphical user interface that is generally indicated by numeral 1400. This process step is virtually identical to that performed by a meeting attendee or customer at a computer located at a kiosk at the facility, e.g., store. The available times for the meeting, e.g., party, are displayed is on an exemplary graphical user interface, that is generally indicated by numeral 1402, where the desired date and time can be selected by click-in inputs that are shown by numerals 1404, 1406, 1408, 1410, 1412, 1414, 1416, 1418, with the date and time associated with click-on input 1404 selected in this illustrative, but nonlimiting, example. There is a pushbutton 1420 that directs the user to the next step in the process 1420. Also, alternative dates and times can be selected as generally indicated by numeral 1430. There is instructive verbiage regarding this feature that is generally indicated by numeral 1431. There are a series of click-on inputs where examples include seven days earlier with the same desired time range 1432, seven days later with the same desired time range 1434, the previous day with the same desired time range 1436, the next day with the same desired time range 1437, and another time range for the same desired day 1438. Any of a wide variety of mathematical offsets can be utilized with this feature. There is a pushbutton 1440 for continuing the process once an alternative, click-on input is selected and another pushbutton 1442 to quit the process.

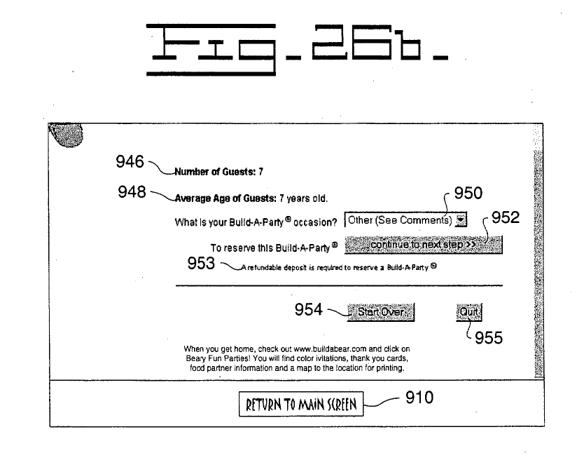

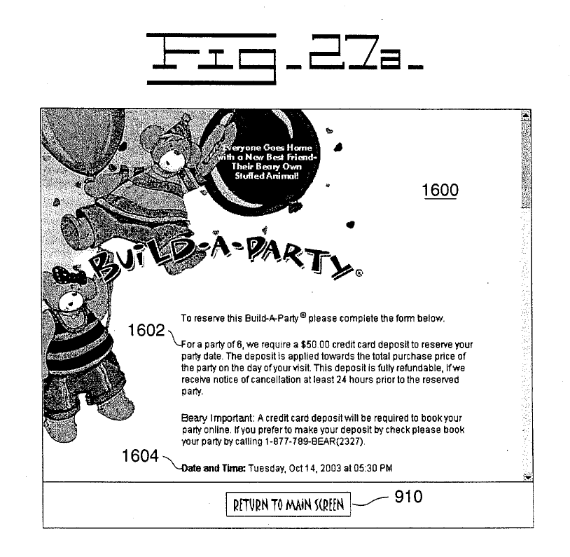

If a particular date and time for the meeting, e.g., party, cannot be selected as determined by the query found in process step <1201>, the process returns to process step <900>, as shown in FIG. 5 to allow the meeting attendee or customer to re-input desired dates and times. If a particular date and time for the meeting, e.g., party, can be selected as determined by the query found in process step <1201>, shown in FIG. 5, by the meeting attendee or customer at a computer located at a kiosk at the facility, e.g., store, then the system is directed to the exemplary graphical user interface that is generally indicated by numeral 940 on FIGS. 26A and 26B, which is also indicated as process step <1202> on FIG. 5. This process step releases dates and times for meetings, e.g., parties, that were not selected and the date and time 942, the location 944, the number of people attending the meeting, e.g., party, 946 and the average age of the people attending the meeting, e.g., party, 948 is outputted. There is a drop-down selector input 950 for the purpose or type of meeting, e.g., party. There is a pushbutton 952 that directs the user to the next step in the process. There is also a pushbutton 954 for starting the process over and a pushbutton 955 for quitting or cancelling the process.

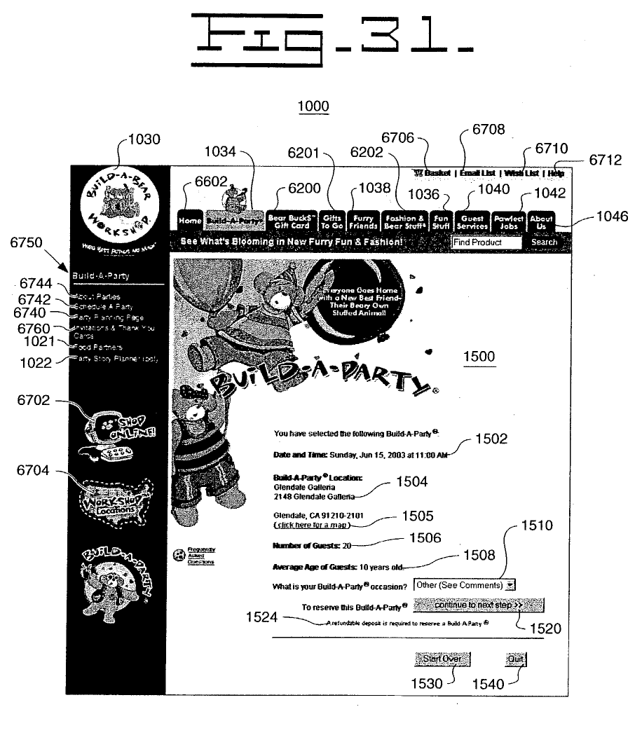

Also, if a particular date and time for the meeting, e.g., party, cannot be selected as determined by the query found in process step <1201 >, the process returns to process step <900>, as shown in FIG. 5 for the meeting attendee or customer utilizing a processor that is electrically connected to a global computer network, e.g., Internet to allow the meeting attendee or customer to re-input desired dates and times. If a particular date and time for the meeting, e.g., party, can be selected as determined by the query found in process step <1201>, shown in FIG. 5, by the meeting attendee or customer at a processor located at located on an global computer system, e.g., Internet, is directed to the exemplary graphical user interface indicated by numeral 1500 on FIG. 31, which is also indicated as process step <1202> on FIG. 5. This process step releases dates and times for meetings, e.g., parties, which were not selected. The date and time 1502, the location 1504, the number of people attending the meeting, e.g., party, 1506, and the average age of the people attending the meeting, e.g., party, 1508. There is a drop-down selector input for the purpose of indicating the type of meeting, e.g., girl scout, boy scout, birthday party, 1510. There is a pushbutton 1520, which directs the user to the next step in the process. There is also a pushbutton 1530 for starting the process over and a pushbutton 1540 for quitting or canceling the process. There is a printed disclaimer regarding a refundable deposit 1524.

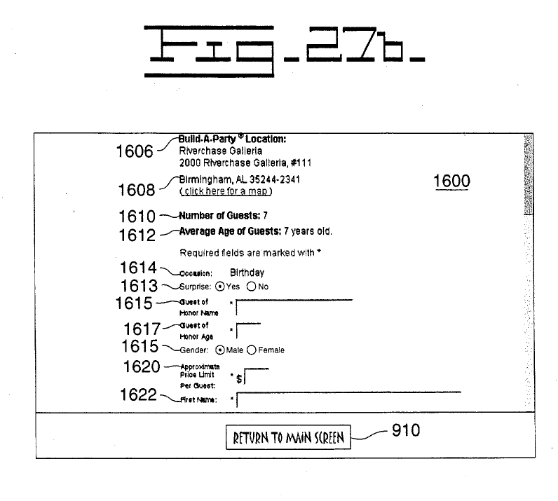

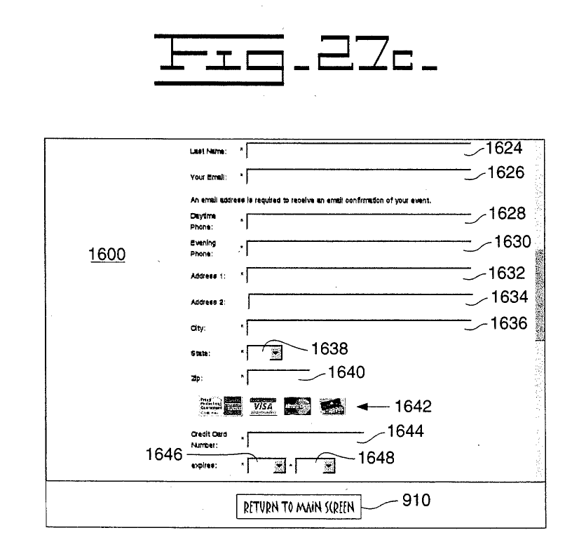

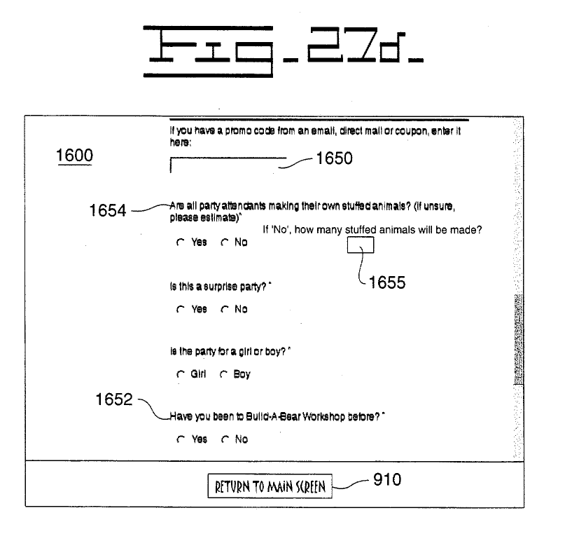

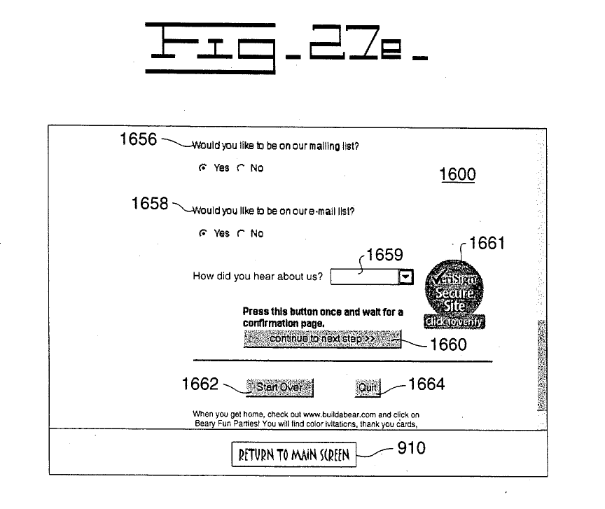

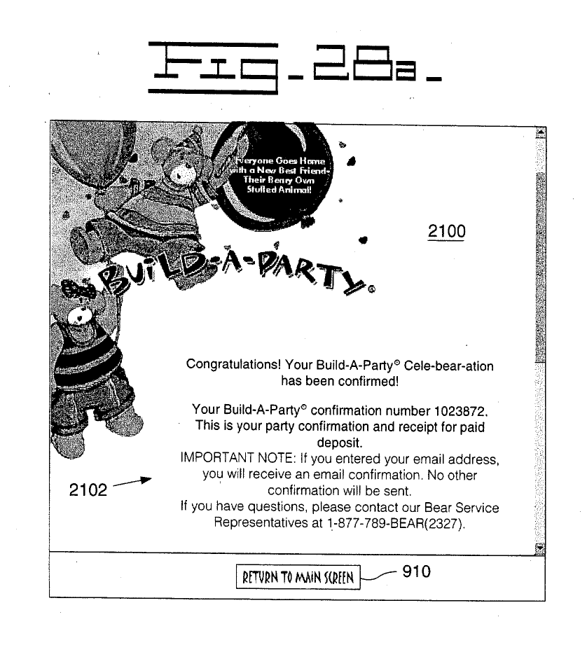

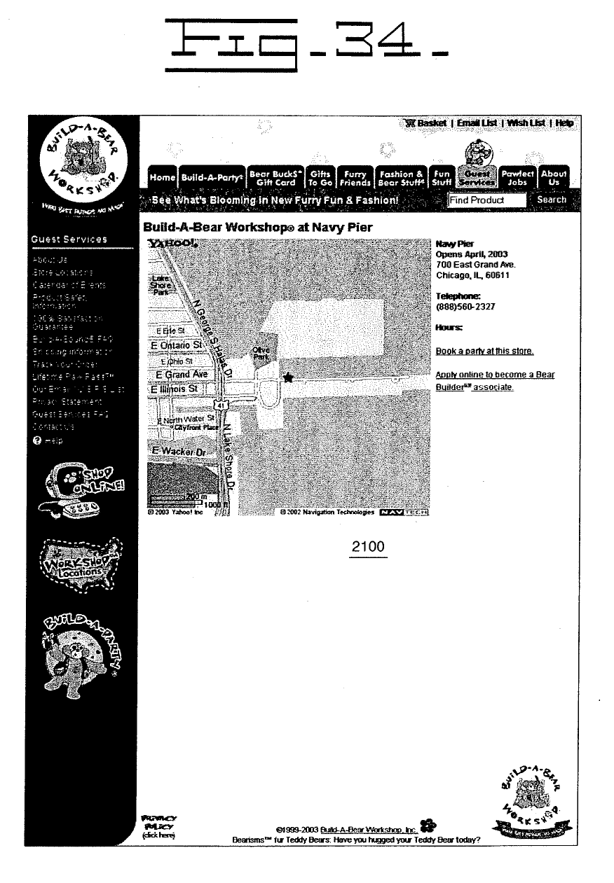

Upon selection of a particular type of meeting, e.g., party, the meeting attendee or customer at a computer located at a kiosk at the facility, e.g., store is directed to the exemplary graphical user interface that is generally indicated by numeral 1600 on FIGS. 27A, 27B and 27C, which is also indicated as process step <1204> on FIG. 5. As shown in FIG. 27A, there is a listing of information including contact information, additional information regarding the meeting, e.g., party, as well as customer service information and a deposit 1602. The selected date and time for the meeting, e.g., party, is displayed as indicated by numeral 1604. The selected location for the meeting, e.g., party, is displayed as indicated by numeral 1606 on FIG. 27B. There is a statement of website location 1608 for going to a map of the location of the facility, e.g., store. This directs the meeting attendee or customer to the exemplary screen display indicated by numeral 2000, as shown on FIG. 34. There is an output for the number of meeting attendees or customers who will attend the meeting, e.g., party, 1610 and an output for the average age of the meeting attendees or customers who will attend the meeting, e.g., party, as indicated by numeral 1612. The occasion of the meeting, e.g., party, is indicated by numeral 1614, e.g., birthday party, girl scout party, boy scout party, and so forth. For the “birthday party” example on FIG. 27B, the guest of honor's name is provided in input 1615 and the age of the guest of honor is provided in input 1617.

There is an input for the approximate price to be paid for each guest at the meeting, e.g., party, as indicated by numeral 1620 on FIG. 27B. The first name of the person reserving the meeting, e.g., party, is provided by the input as indicated by numeral 1622. The last name of the person reserving the meeting, e.g., party, is provided by the input as indicated by numeral 1624 on FIG. 27C. The e-mail address of the person reserving the meeting, e.g., party, is provided by the input as indicated by numeral 1626. The daytime phone number of the person reserving the meeting, e.g., party, is provided by the input as indicated by numeral 1628. The evening phone number of the person reserving the meeting, e.g., party, is provided by the input as indicated by numeral 1630. A first address line of the person reserving the meeting, e.g., party, is provided by the input as indicated by numeral 1632 and a second address line of the person reserving the meeting, e.g., party, is provided by the input as indicated by numeral 1634. The city of the person reserving the meeting, e.g., party, is provided by the input as indicated by numeral 1636. A drop-down selector input for the state of the person reserving the meeting, e.g., party, is provided as indicated by numeral 1638. The postal zip code of the person reserving the meeting, e.g., party, is provided by the input as indicated by numeral 1640. The logos from credit or debit card companies that are accepted for providing a deposit is indicated by numeral 1642 on FIG. 27C. There is an input for a credit or debit card number 1644 followed by a expiration month 1646 and expiration year 1648 for the credit card as shown on FIG. 27C, respectively.

There is an input for a promotional code 1650 from an e-mail, direct mail or coupon as shown on FIG. 27D, respectively. There is also a request for additional customer service information from the customer. Examples include a click-on input regarding as to whether the customer has ever been to a facility, e.g., store 1652, a click-on input as to whether all meeting attendees or customers attending the meeting, e.g., party, will be purchasing products 1654. There is an input 1655 to indicate the number of meeting attendees or customers purchasing products when the number is less than all of the customers attending a particular meeting, e.g., party.

There is a click-on input 1656 shown on FIG. 27E, which is for whether or not the customer would like to be placed on a mailing list. There is also a click-on input 1658, which is for whether or not the customer would like to be placed on an e-mail list. There is a pushbutton 1660 that directs the user to the confirmation page. There is also a pushbutton to start the process over as indicated by numeral 1662 and a pushbutton to quit or cancel the process as shown by numeral 1664. The contact information and deposit can be received in the store electronically. There is an icon or emblem 1661 that indicates that this is a secure website. The information may be encrypted utilizing 128-bit encryption technology such as that provided by VERISIGN®. VERISIGN® is a federally registered trademark of Verifone, Inc., having a place of business at 4988 Great America Parkway, Santa Clara, Calif. 95054. An example of a type of organization that utilizes VERISIGN® encryption technology to receive credit or debit card payments is www.surepay.com, operated by SurePay L. P., having a place of business at 225 Broad Hollow Road, Melville, N.Y. 11746. Another illustrative, but nonlimiting, feature may include a drop-down input 1659 so that the user, e.g., customer, can indicate how he or she heard about the system associated with the present invention.

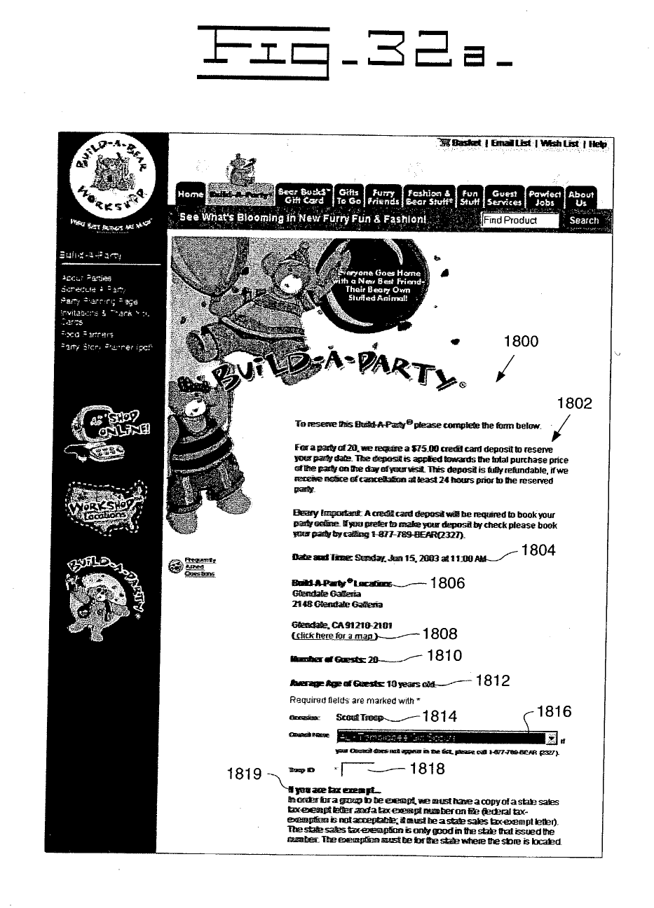

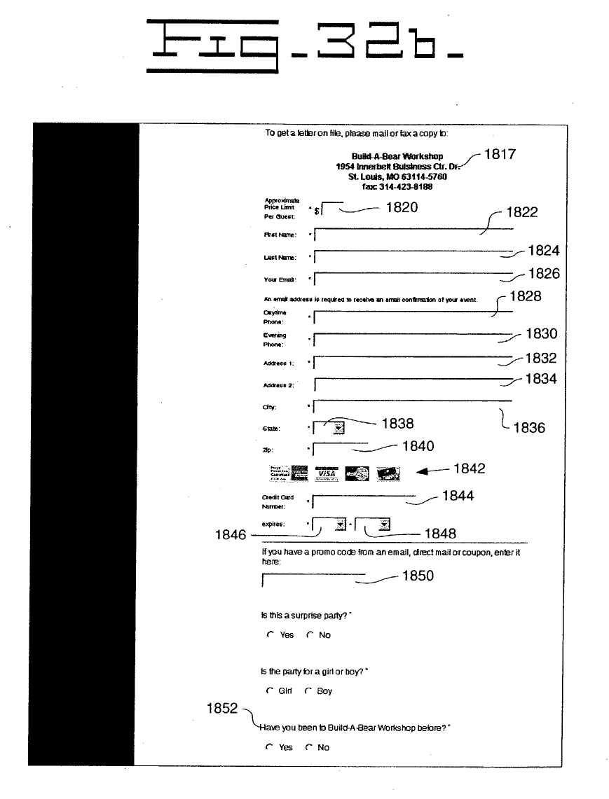

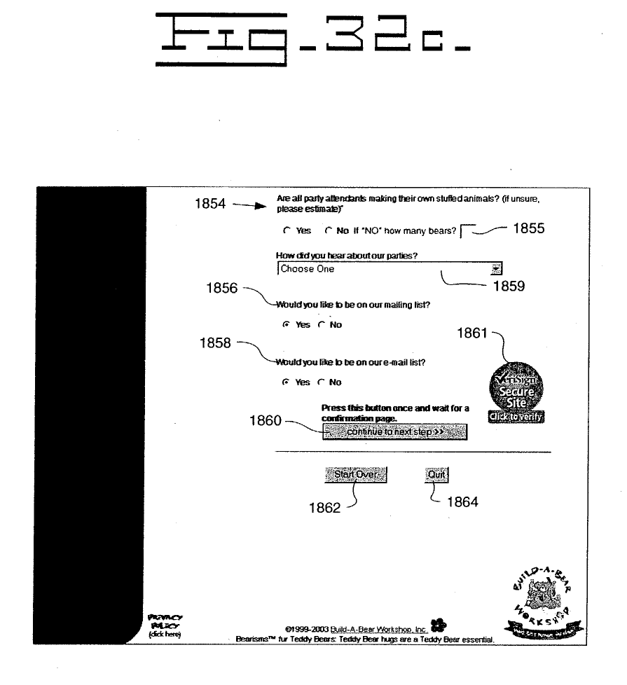

Another illustrative, but nonlimiting example of another type of meeting is that a party for a scout troop. Upon selection of this particular type of meeting, e.g., scout troop party, the customer or meeting attendee at a computer that is connected to a global computer network, e.g., Internet, is directed to the exemplary graphical user interface that is generally indicated by numeral 1800 on FIG. 32A, which is also indicated as process step <1204> on FIG. 5. This step provides an output of information regarding the reservation process 1802 on FIG. 32A. The selected date and time for the meeting, e.g., party, is displayed as indicated by numeral 1804. The selected location for the meeting, e.g., party, is displayed as indicated by numeral 1806. There is a hyperlink 1808 for going to a map of the location of the facility, e.g., store. This directs the meeting attendee or customer to the exemplary screen display indicated by numeral 2000, as shown on FIG. 34. There is an output for the number of meeting attendees or customers who will attend the meeting, e.g., party, 1810 and an output for the average age of the meeting attendees or customers who will attend the meeting, e.g., party, as indicated by numeral 1812. The occasion of the meeting, e.g., party, is indicated by numeral 1814, e.g., scout troop meeting. As also shown on FIG. 32A, the council for the scout troop is provided in a drop-down selector input 1816 and the scout troop identification number is provided in input 1818. There is verbiage regarding tax exempt status 1819 and an address to mail verification of tax exempt status indicated by numeral 1817 on FIG. 32B.

There is an input for the approximate price to be paid for each guest at the meeting, e.g., party, as indicated by numeral 1820 on FIG. 32B. The first name of the person reserving the meeting, e.g., party is provided by the input as indicated by numeral 1822. The last name of the person reserving the meeting, e.g., party, is provided by the input as indicated by numeral 1824. The e-mail address of the person reserving the meeting, e.g., party, is provided by the input as indicated by numeral 1826. The daytime phone number of the person reserving the meeting, e.g., party, is provided by the input as indicated by numeral 1828. The evening phone number of the person reserving the meeting, e.g., party, is provided by the input as indicated by numeral 1830. A first address line of the person reserving the meeting, e.g., party, is provided by the input as indicated by numeral 1832 and a second address line of the person reserving the meeting, e.g., party, is provided by the input as indicated by numeral 1834. The city of the person reserving the meeting, e.g., party, is provided by the input as indicated by numeral 1836. A drop-down selector input for the state of the person reserving the meeting, e.g., party, is provided as indicated by numeral 1838. The postal zip code of the person reserving the meeting, e.g., party, is provided by the input as indicated by numeral 1840. The logos from credit or debit card companies that are accepted for providing a deposit is indicated by numeral 1842. There is an input for a credit or debit card number 1844. There is a drop-down selector input 1846 for inputting the month for the credit card expiration date and a drop down input 1848 for the year of the credit card expiration date. There is an input for a promotional code 1850. There is also a request for additional customer service information from the customer. Examples include a click-on input regarding as to whether the customer has ever been to a facility, e.g., store, 1852 shown on FIG. 32B, a click-on input as to whether all meeting attendees or customers attending the meeting, e.g., party, will be purchasing products 1854 shown on FIG. 32C. There is a drop-down selector input 1855 to indicate the number of meeting attendees or customers purchasing products when the number is less than all of the customers attending a particular meeting, e.g., party.

There is a click-on input 1856, which is for whether or not the customer would like to be placed on a mailing list. There is also a click-on input 1858, which is for whether or not the customer would like to be placed on an e-mail list. There is a pushbutton 1860 that directs the user to the confirmation page. Another illustrative, but nonlimiting, feature may include a drop-down input 1859 so that the user, e.g., customer, can indicate how he or she heard about the system associated with the present invention. There is a hyperlink icon 1861 representing the provider of encryption technology, e.g., VERISIGN®. This will direct the user to specific information regarding the security provided by the organization associated with the system of the present invention. This information may be encrypted utilizing 128-bit encryption technology such as that provided by VERISIGN®. VERISIGN® is a federally registered trademark of Verifone, Inc., having a place of business at 4988 Great America Parkway, Santa Clara, Calif. 95054. An example of a type of organization that utilizes VERISIGN® encryption technology to receive credit or debit card payments is www.surepay.com, operated by SurePay L. P., having a place of business at 225 Broad Hollow Road, Melville, N.Y. 1174.

There is also a pushbutton to start the process over as indicated by numeral 1862 and a pushbutton to quit or cancel the process as shown by numeral 1864, as shown on FIG. 32C. This process step is shown on FIG. 5 by numeral <1206>. There is a query as to whether this credit or debit card information is rejected as process step <1207>. If the answer to the query is affirmative, the process returns to process step <1204> and if the answer to the query is negative, the process goes to display a confirmation of the meeting, e.g., party <1208>.

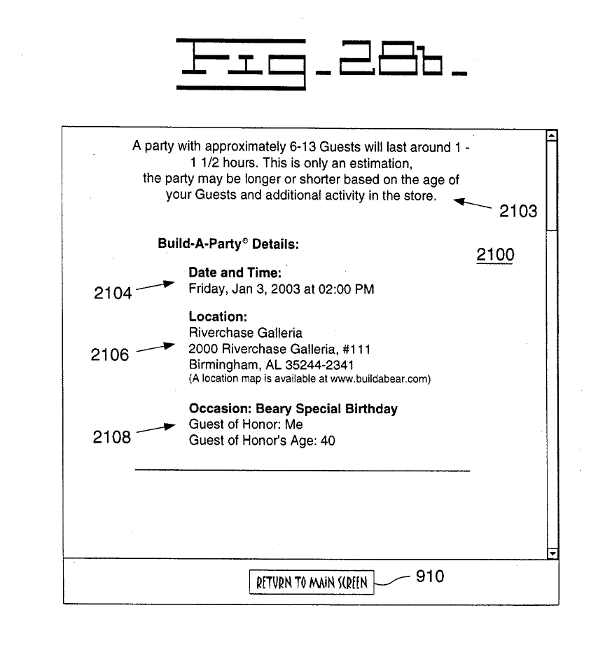

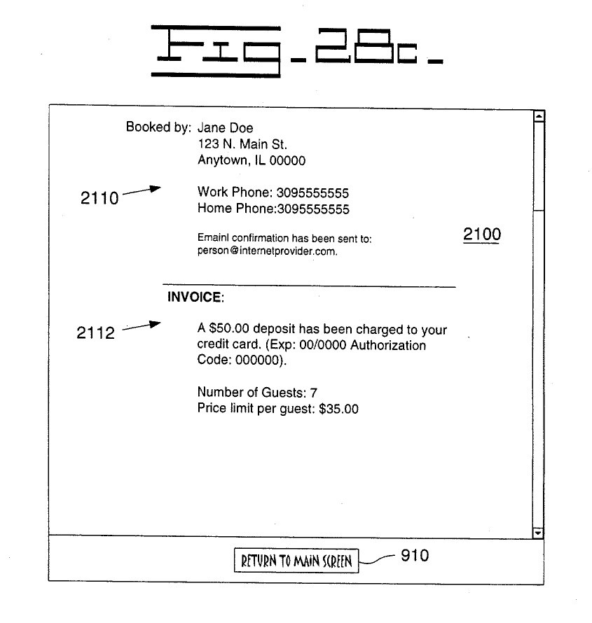

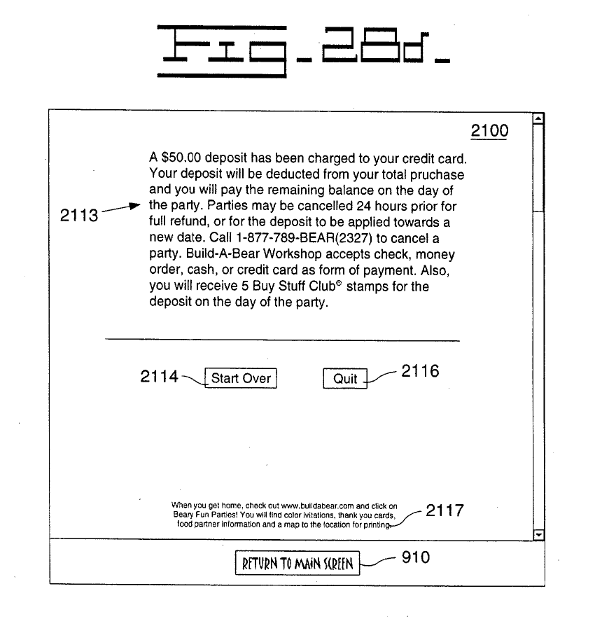

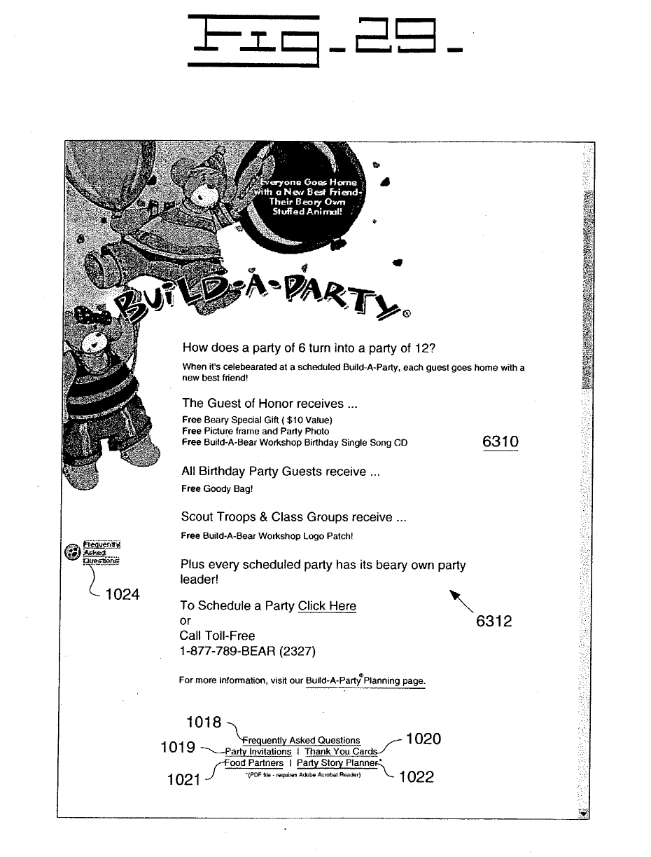

Upon the clicking of the pushbutton 1660 on FIG. 27E or pushbutton 1860 on FIG. 32C, the customer at a computer located at a kiosk at the facility, e.g., store is directed to the exemplary graphical user interface that is generally indicated by numeral 2100 on FIGS. 28A, 28B, 28C and 28D, which is also indicated as process step <1208> on FIG. 5 to receive a confirmation of the reservation of the meeting, e.g., party. This includes an indication that the meeting, e.g., party, has been confirmed 2102 that that an additional e-mail confirmation may be received by the user without any additional confirmation. An additional phone number is provided as shown in FIG. 28A. An e-mail confirmation is listed on FIG. 5 as process step <1210>.

Referring now to FIG. 28B, additional verbiage on the meeting, e.g., party may be provided 2103. The details regarding the date and time of the meeting, e.g., party, 2104, the location of the meeting, e.g., party, 2106 and the occasion for the meeting, e.g., party including the name of the guest of honor and the guest of honor's age 2108.

Referring now to FIG. 28C, the user, e.g., customer who has booked the meeting, e.g., party, is listed along with his or her address, work phone number, home phone numbers and e-mail address including indication that a confirmation e-mail was sent to that e-mail address.

This is followed by an invoice 2112 that indicates a credit card charge has been made with the number of guests and the price limit per guest.

Referring now to FIG. 28D, additional information is provided 2113 including, but not limited to, the deductibility of the deposit from the expenses of the meeting, e.g., party is listed as well as information as how to cancel the meeting, e.g., party, including time limits and contact phone numbers. The method of payment and information regarding stamps/coupons can also be provided. There may be additional marketing information 2117 that lists the Internet website, e.g., www.buildabear.com, for the organization as well as promotes other services or features provided by the organization such as invitations, cards, food suppliers, location maps, and so forth.

The feature of finding the location of a facility, e.g., store, that may be optimal for the meeting or event, which is accessible through hyperlink 6704 on FIG. 31 includes inputting desired states or zip codes, providing an output of facilities, e.g., stores in that area. One of the outputted facilities, e.g., stores, can be selected. This will direct the user to a graphical output screen that is generally indicated by numeral 2100 on FIG. 34. In addition to a map of the facility, e.g., store, additional information can include an address, telephone numbers, hours of operation, directions to the facility, e.g., store, potential food suppliers. The user can either book or reserve a meeting or event at this facility, e.g., store, or apply for employment through additional hyperlinks.

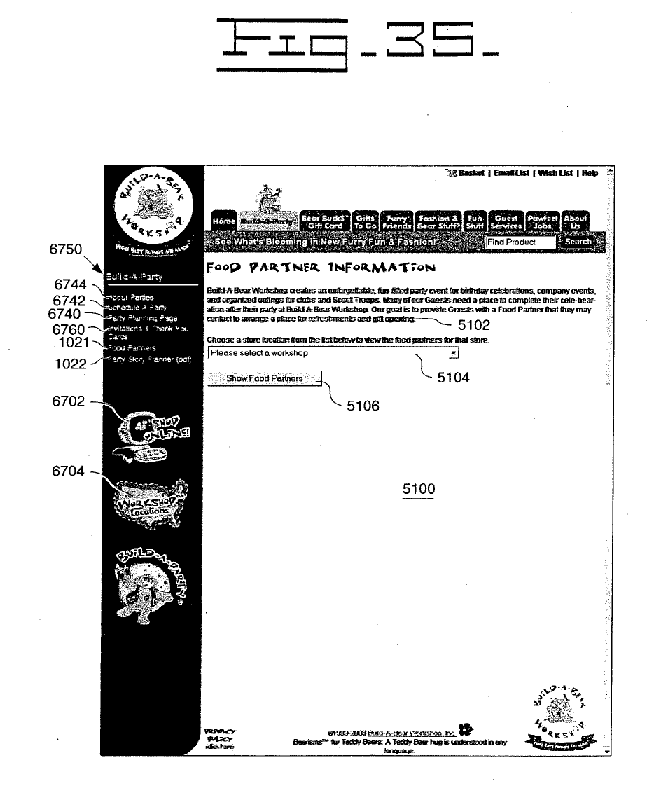

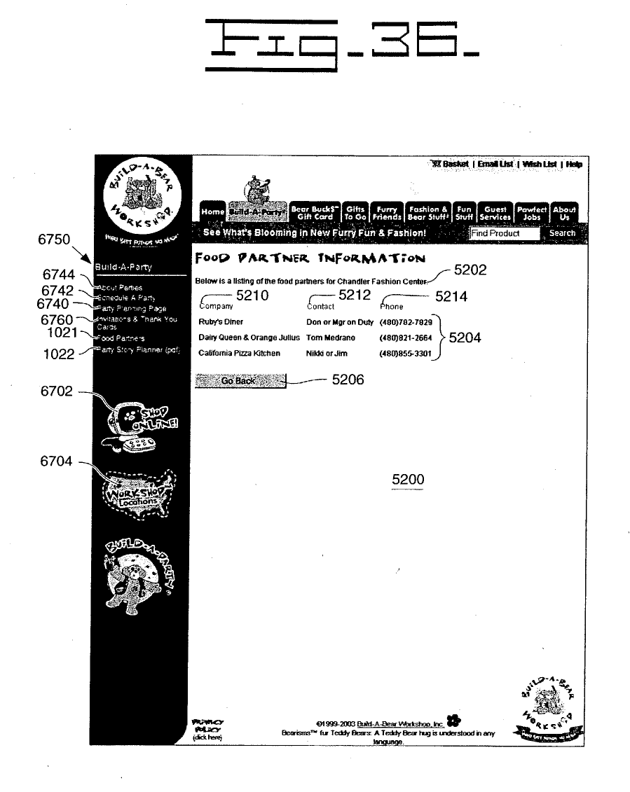

The feature of ascertaining food providers for a particular facility, e.g., store, location that may be optimal for the meeting or event, which is accessible through hyperlink 1021 on FIG. 31 includes a graphical user interface screen that is generally indicated by numeral 5100 on FIG. 35. There is some written information regarding the use of food providers that is generally indicated by numeral 5102. This is followed by a drop-down input 5104 that allows the user to select a particular facility, e.g., store. The user than clicks on a graphical user interface pushbutton to go to the graphical user interface screen indicated by numeral 5200 on FIG. 36. This provides a listing of potential food providers/suppliers for a particular facility, e.g., store 5202. This includes a column that lists the particular food providers 5210, a column of contact personnel associated with each food provider 5212 and a column of phone numbers associated with each contact person 5214. There is a graphical user interface pushbutton 5206 that allows the user to transfer back to the previous screen 5100 on FIG. 35.

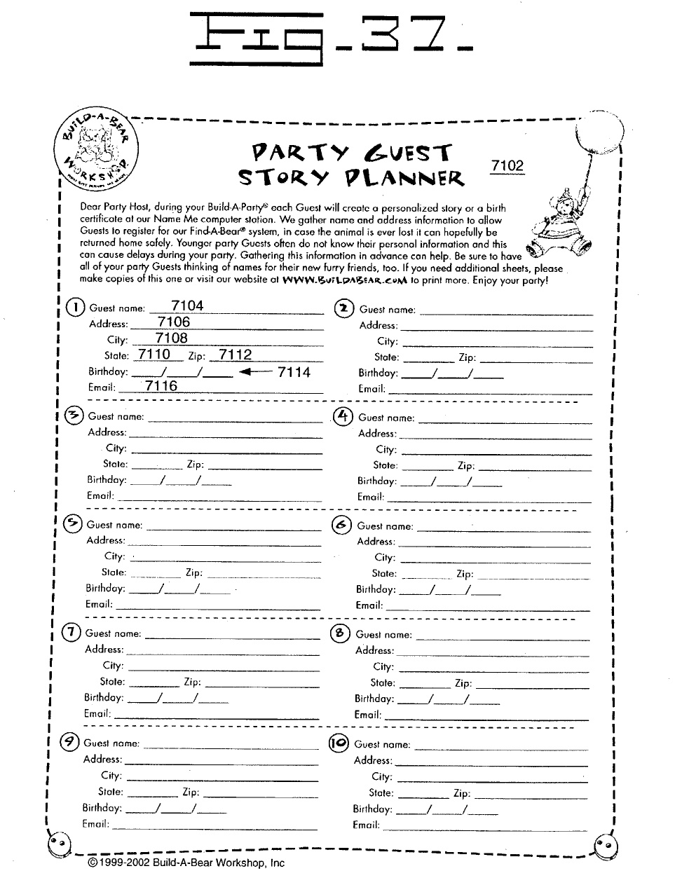

The previously referenced hyperlink 1022, as shown in FIG. 31, for planing a story or certificate, e.g., birth certificate, that can be utilized in conjunction with the meeting, e.g., party, by a customer utilizing a global computer network, e.g., Internet that is indicated by process step <1108> on FIG. 5. The user is directed to a screen that allows the user to printout a form that is generally indicated by numeral 7102 on FIG. 37. There is an line for a customer or guest name 7104, a line for the customer's or guest's address 7106, a line for the customer's or guest's city 7108, a line for the customer's or guest's state 7110, a line for the customer's or guest's zip code 7112, a line for the customer's or guest's date of birth 7106 and a line for the customer's or guest's e-mail address 7116. This information can be utilized to create a personalized story or certificate for the guest or customer.

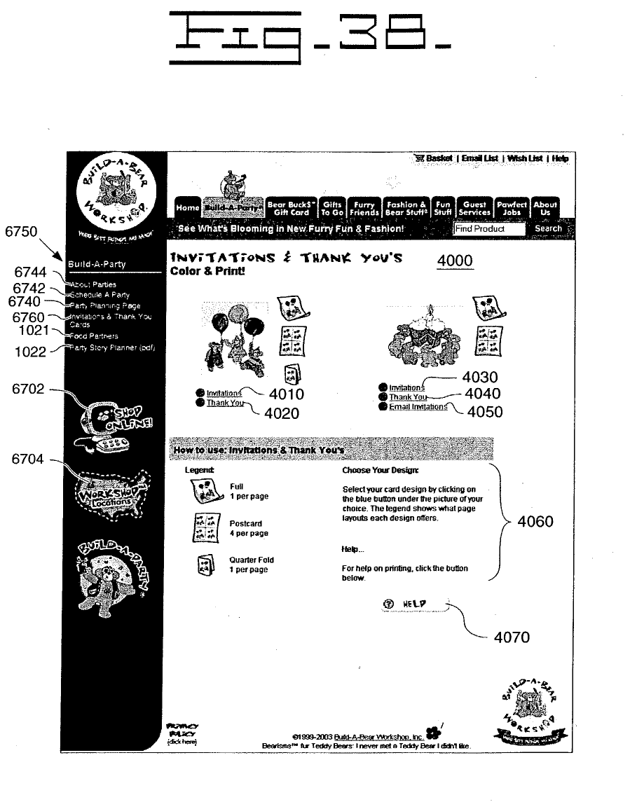

The previously reference hyperlink 6760, as shown on FIG. 31, for providing invitations to the meeting, e.g., party, that is indicated by process step <1106>, on FIG. 5, as well as for providing thank-you cards for the meeting, e.g., party, that is indicated by process step <1104>, on FIG. 5, directs the user to the graphical user interface that is generally indicated by numeral 4000 on FIG. 38. This graphical user interface screen 4000 includes instructional verbiage 4050 and well as a graphical user interface pushbutton 4070 to obtain additional help or assistance.

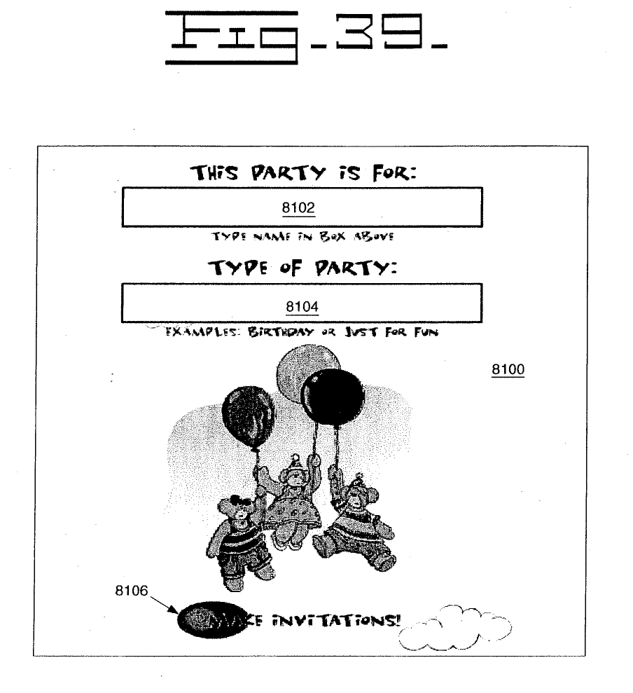

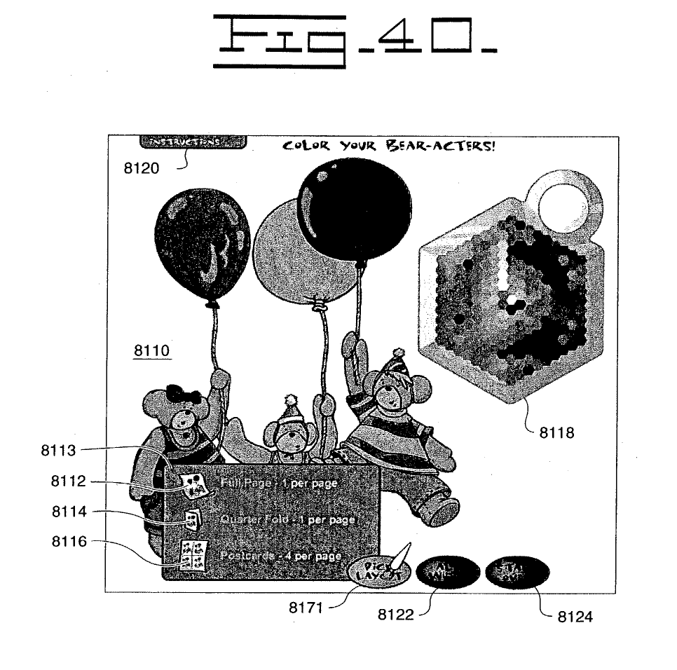

There is a first hyperlink 4010 and a second hyperlink 4030 that directs the user to a graphical user interface screen for generating invitations for a meeting or event, e.g., birthday party. Although each hyperlink 4010 and 4030 directs the user to a different graphical design, one illustrative, but nonlimiting, example includes the graphical user interface screen 8100, shown on FIG. 39, that provides an input for the guest of honor for the meeting, e.g., party 8102 and the type of meeting, e.g., birthday party 8104. There is a graphical user interface pushbutton 8106 that allows the user to create invitations by directing the user to the graphical user interface screen indicated by numeral 8110 on FIG. 40. On graphical user interface screen 8110, there is a graphical user interface pushbutton 8120 to obtain instructions regarding creation of invitations, a color palette 8118 for coloring the invitations, a graphical user interface pushbutton 8121 for determining the form of the invitation 8113 that allows the user to select a full page invitation 8112, a quarter fold invitation with one pet page 8114 and invitation postcards with four per page 8116. The invitation can be made all white by clicking on the graphical user interface pushbutton 8122. There is also the ability to start the coloring process over by the user clicking on the graphical user interface pushbutton 8124.

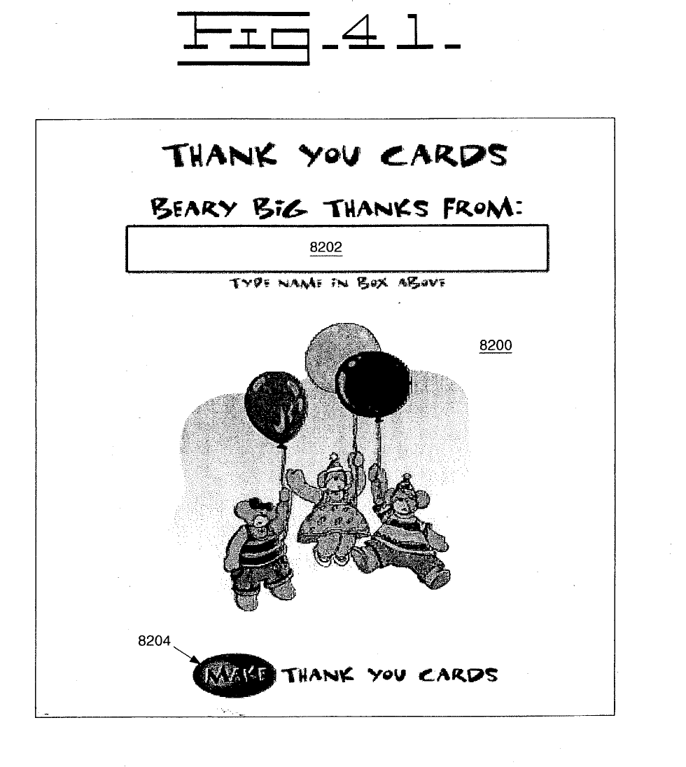

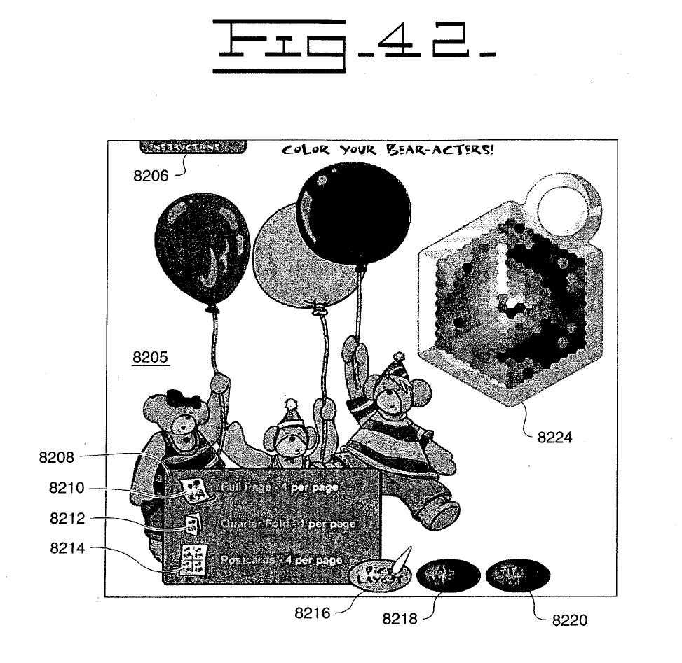

There is a third hyperlink 4020 and a fourth hyperlink 4040 that directs the user to a graphical user interface screen for generating thank-you cards to individuals that have attended a meeting or event, e.g., birthday party. Although each hyperlink 4020 and 4040 directs the user to a different graphical design, one illustrative, but nonlimiting, example includes the graphical user interface screen 8200, shown on FIG. 41, that provides an input for the name of the person sending the thank you cards for attending the meeting or event, e.g., birthday party, 8202. There is a graphical user interface pushbutton 8204 that allows the user to create thank you cards by directing the user to the graphical user interface screen indicated by numeral 8205 on FIG. 42. On graphical user interface screen 8205, there is a graphical user interface pushbutton 8206 to obtain instructions regarding creation of thank you cards, a color palette 8224 for coloring the thank you cards, a graphical user interface pushbutton 8216 for determining the form of the thank you card 8208 that allows the user to select a full page thank you card 8210, a quarter fold thank you card with one per page 8212 and thank you postcards with four per page 8214. The invitation can be made all white by clicking on the graphical user interface pushbutton 8218. There is also the ability to start the coloring process over by the user clicking on the graphical user interface pushbutton 8220.

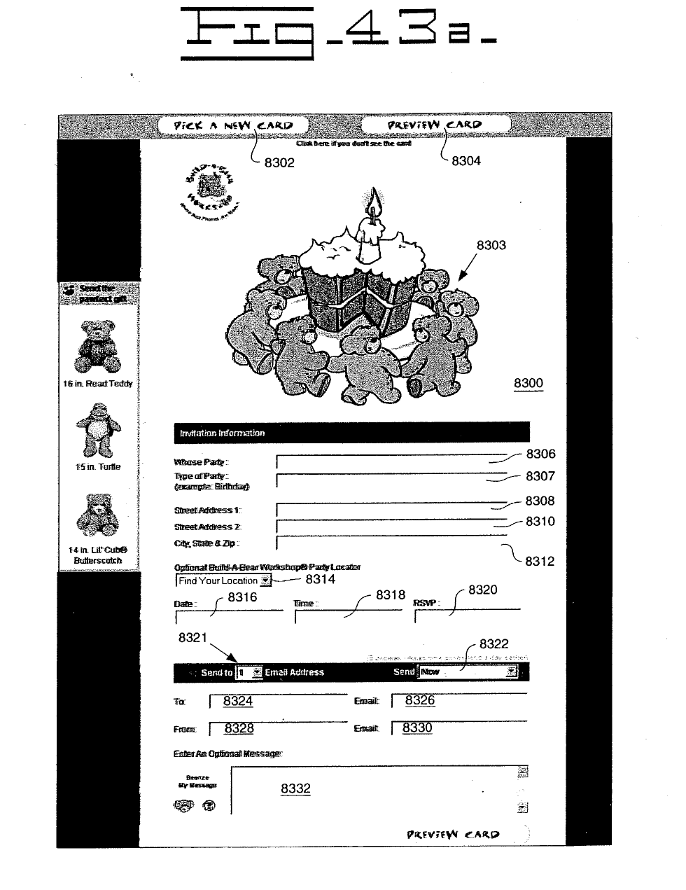

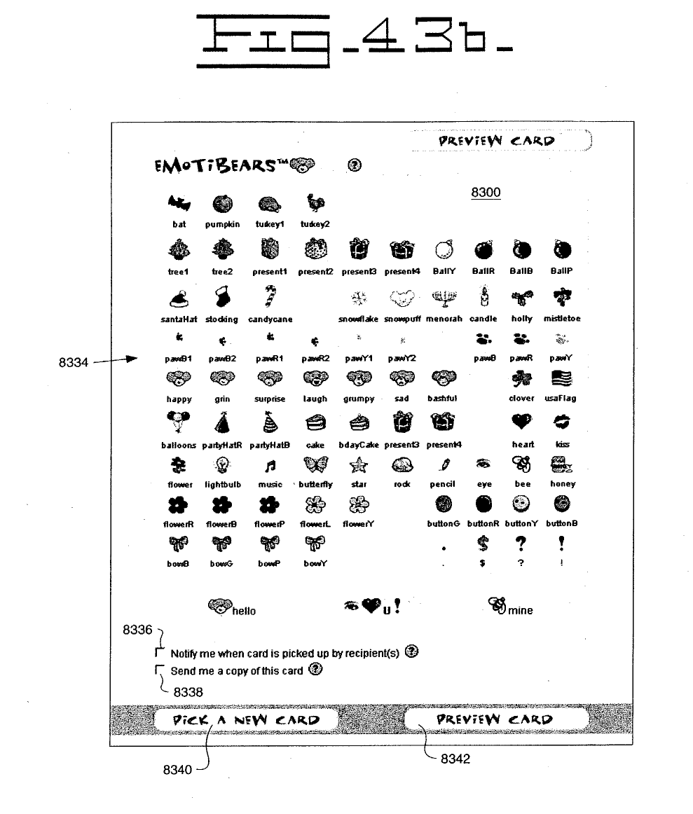

There is a fifth hyperlink 4050 that directs the user to a graphical user interface screen for generating e-mail invitations for a meeting or event, e.g., birthday party. Referring now to FIGS. 43A and 43B, there are two graphical user interface pushbuttons to select a design for an e-mail invitation 8302 and 8340 from a wide assortment of different designs for various occasions. On illustrative, but nonlimiting, design is indicated by numeral 8303. There is a typed-in input 8306 for the name of the guest of honor for the meeting or event, a typed-in input 8307 for the occasion of the meeting or event, a typed-in input 8308 for a first line of a street address for the name of the guest of honor for the meeting or event, a typed-in input 8310 for a second line of a street address for the name of the guest of honor for the meeting or event, a typed-in input 8312 for a city, state and zip code for the name of the guest of honor for the meeting or event, a drop-down input 8314 for the name of the facility, e.g., store that will host the meeting or event, a typed-in input 8316 for the date of the event, a typed-in input 8318 for the time of the event, a typed-in input 8320 for the date when an indication of whether the person receiving the e-mail will be attending the meeting or event (RSVP). There is a drop-down input 8321 for the number of recipients for this particular e-mail and a drop-down input 8322 to provide the time for delivery, e.g., now or a wide selection of dates. There is an input 8324 to indicate the name of the person being invited to the meeting or event and an input 8326 to provide that person's e-mail address. There is an input 8328 to indicate the name of the person providing the invitation to the meeting or event and an input 8330 for that person's e-mail address.

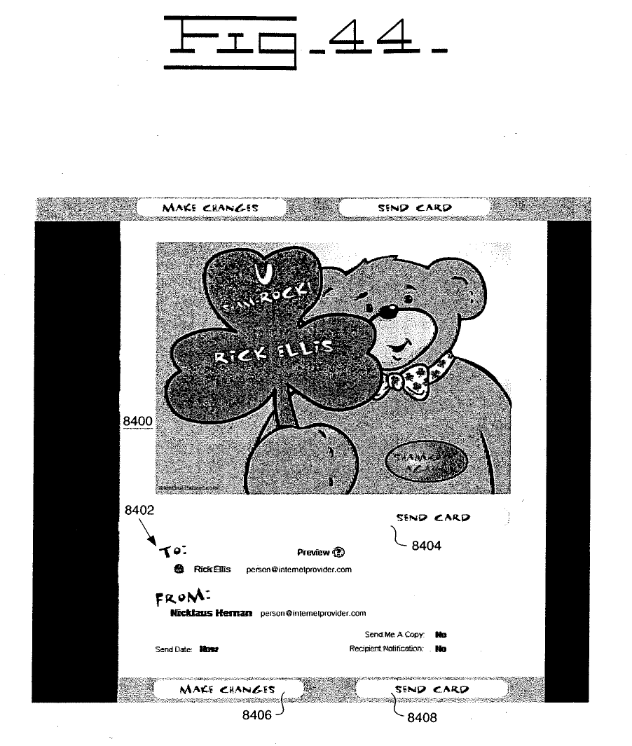

There is an input to provide an additional text message 8332 that can be augmented by graphical artwork 8334. There is a click-on input 8336 to request an indication that the e-mail card has been picked-up by a recipient and another click-on input 8338 to provide the person sending the invitation a copy of the invitation that was sent to the recipient. There are two graphical user interface pushbuttons 8304 and 8342, respectively, that allow the user to preview the e-mail that is being sent prior to transmission. Upon clicking on the preview function 8304 or 8342, the user is directed to the graphical user interface screen indicated by numeral 8400 on FIG. 44. This includes information on the person sending and receiving the e-mail, transmission date, whether recipient notification information is provided to sender and whether a copy is provided to the sender. There are two graphical user interface pushbuttons 8404 and 8408, respectively, for transmitting the e-mail and a graphical user interface pushbutton 8406 that allows the user to make changes to the e-mail prior to transmission.

Although the preferred embodiment of the present invention and the method of using the same has been described in the foregoing specification with considerable details, it is to be understood that modifications may be made to the invention, which do not exceed the scope of the appended claims and modified forms of the present invention done by others skilled in the art to which the invention pertains will be considered infringements of this invention when those modified forms fall within the claimed scope of this invention.

1. A method for managing a meeting utilizing at least one database comprising: selecting a facility;
selecting a date for the meeting;
inputting a number of people to attend the meeting;
selecting a portion of a day in which to schedule the meeting;
retrieving from the database at least one available time and date for the meeting at the selected facility;
selecting a particular time and date for the meeting at the selected facility; from the at least one retrieved time and date for the meeting; and
receiving an output of a confirmation of a reserved meeting.

2. The method for managing a meeting as set forth in claim 1, which further includes designating a category of meeting or a type of meeting.

3. The method for managing a meeting as set forth in claim 1, which further includes reserving the meeting through an electronic payment mechanism.

4. The method for managing a meeting as set forth in claim 3, wherein the electronic payment mechanism validates or rejects encrypted payment information from a credit or debit card.

5. The method for managing a meeting as set forth in claim 1, which further includes inputting information regarding a person reserving the meeting.

6. The method for managing a meeting as set forth in claim 5, wherein the information regarding the person is selected from the group consisting of personal information and household information.

7. The method for managing a meeting as set forth in claim 1, which further includes automatically generating a confirmation letter or confirmation e-mail when the meeting is scheduled or the meeting is cancelled.

8. The method for managing a meeting as set forth in claim 1, which further includes inputting information regarding the meeting.

9. The method for managing a meeting as set forth in claim 1, which further includes outputting all meetings that occur at a selected facility during a predetermined time period.

10. The method for managing a meeting as set forth in claim 8, which further includes obtaining at least one detail regarding a particular meeting that occurs at a selected facility during a predetermined time period.

11. The method for managing a meeting as set forth in claim 1, which further includes:
inputting information in a plurality of data fields; and
outputting a text file with the inputted data fields appearing in the outputted text file.

12. The method for managing a meeting as set forth in claim 11, wherein the outputted text file is selected from the group consisting of a certificate, a book, a card, a cut-out, a flag, a decal, clothing and combinations thereof.

13. The method for managing a meeting as set forth in claim 1, which further includes outputting at least one alternative date and time for the desired meeting.

14. The method for managing a meeting as set forth in claim 13, wherein the at least one alternative date and time is selected from the group consisting of a predetermined number of days before a desired date, a predetermined number of days after the desired date, another portion of a day on the desired date and combinations thereof.

15. The method for managing a meeting as set forth in claim 1, which further includes reserving a block of time at a facility based on the confirmed, reserved meeting.

16. The method for managing a meeting as set forth in claim 16, which further includes querying the database regarding confirmed, reserved meetings for a facility.

17. The method for managing a meeting as set forth in claim 1, which further includes creating, viewing or tracking a product or service order.

18. A method for managing a meeting utilizing at least one database comprising:
selecting a facility;
selecting a date for the meeting;
inputting a number of people to attend the meeting;
selecting a portion of a day in which to schedule the meeting;
retrieving from the database at least one available time and date for the meeting at the selected facility;
selecting a particular time and date for the meeting at the selected facility; from the at least one retrieved time and date for the meeting;
reserving the meeting through an electronic payment mechanism; and
receiving an output of confirmation of a reserved meeting.

19. A method for managing a meeting utilizing at least one database comprising:
selecting a facility;
selecting a date for the meeting;
inputting a number of people to attend the meeting;
selecting a portion of a day in which to schedule the meeting;
selecting at least one alternative date or at least one alternative portion of the day for the desired meeting;
retrieving from the database at least one available time and date for the meeting at the selected facility;
selecting a particular time and date for the meeting at the selected facility; from the at least one retrieved time and date for the meeting; and
receiving an output of a confirmation of a reserved meeting.

20. A computer system for managing a meeting utilizing at least one database associated with at least one processor comprising:
an input mechanism that receives a selected facility, a selected date for a meeting, a number of people to attend the meeting, and a portion of a day in which to schedule the meeting; and
an output mechanism that retrieves from the database of at least one available time and date for the meeting at the selected facility, wherein the input mechanism further includes receiving an input for one particular date, time and facility of the at least one retrieved time and date for the meeting at the selected facility and the output mechanism provides a confirmation of the selected date, time and facility for the meeting.

21. The computer system for managing a meeting as set forth in claim 20, wherein the input mechanism receives a category or type of meeting.

22. The computer system for managing a meeting as set forth in claim 20, further includes an electronic payment mechanism for reserving the meeting.

23. The computer system for managing a meeting as set forth in claim 22, wherein the electronic payment mechanism validates or rejects encrypted payment information from a credit or debit card.

24. The computer system for managing a meeting as set forth in claim 20, wherein the input mechanism receives information regarding a person reserving the meeting.

25. The computer system for managing a meeting as set forth in claim 24, wherein the information regarding the person is selected from the group consisting of personal information and household information.

26. The computer system for managing as set forth in claim 20, wherein the input mechanism receives information regarding the meeting.

27. The computer system for managing a meeting as set forth in claim 20, wherein the output mechanism provides at least one detail regarding a particular meeting that occurs at a selected facility during a predetermined time period.

28. The computer system for managing a meeting as set forth in claim 20, wherein the input mechanism receives information that appears in data fields and the output mechanism displays at least one text file with the inputted data fields appearing therein.

29. The computer system for managing a meeting as set forth in claim 28, wherein the outputted text file is selected from the group consisting of a certificate, a book, a card, a cut-out, a flag, a decal, clothing and combinations thereof.

30. The computer system for managing a meeting as set forth in claim 20, wherein the output mechanism provides at least one alternative date and time for the desired meeting.

31. The computer system for managing a meeting as set forth in claim 20, wherein the alternative dates and times are selected from the group consisting of a predetermined number of days before the desired date, a predetermined number of days after the desired date, another range of times on the desired date and combinations thereof.

32. A computer system for managing meetings utilizing at least one database and at least one processor comprising:
an input mechanism that receives a selected facility, a selected date for a meeting, a number of people to attend the meeting, a portion of a day in which to schedule the meeting; and
an output mechanism that retrieves from the database of at least one available time and date for the meeting at the selected facility, wherein the input mechanism further includes receiving an input for one particular date, time and facility of the at least one retrieved time and date for the meeting at the selected facility;
an electronic payment mechanism for receiving a deposit to reserve the meeting, wherein the output mechanism provides a confirmation of the selected date, time and facility for the meeting.

33. A computer system for managing meetings utilizing at least one database and at least one processor comprising:
an input mechanism that receives a selected facility, a selected date for a meeting, a number of people to attend the meeting, a portion of a day in which to schedule the meeting; and
an output mechanism that retrieves from the database of at least one available time and date for the meeting at the selected facility and at least one alternative date and time for the meeting, wherein the input mechanism further includes receiving an input for one particular date, time and facility of the at least one retrieved time and date for the meeting at the selected facility and the output mechanism provides a confirmation of the selected date, time and facility for the meeting.

34. A computer software interface that is capable of being connected to at least one database for managing a meeting utilizing a database comprising:
an input that provides a facility selection;
an input that provides a meeting date selection;
an input that provides an attendance number for a meeting;
an input that selects a portion of a day in which to schedule the meeting;
an output that retrieves at least one available time and date for the meeting at the selected facility;
an input that provides a selection of a particular time and date for the meeting at the selected facility; from the at least one retrieved time and date for the meeting; and
an output that provides a confirmation of a reserved meeting.

35. The computer software interface for managing a meeting as set forth in claim 34, further includes an output of alternative dates and times for the meeting.

36. The computer software interface for managing a meeting as set forth in claim 34, further includes an electronic payment mechanism for making a deposit for the reserved, confirmed meeting.

37. A computer software interface that is capable of being connected to at least one database for managing a meeting utilizing a database comprising:
an input that provides a facility selection;
an input that provides a meeting date selection;
an input that provides an attendance number for a meeting;
an input that selects a portion of a day in which to schedule the meeting;
an input that selects at least one alternative date or at least one alternative portion of a day for the desired meeting;
an output that retrieves at least one available time and date for the meeting at the selected facility;
an input that provides a selection of a particular time and date for the meeting at the selected facility; from the at least one retrieved time and date for the meeting; and
an output that provides a confirmation of a reserved meeting.
